(19) United States
(12) Patent Application Publication
(10) Pub. No.: US 2016/0239780 A1
(43) Pub. Date: Aug. 18, 2016

(54) PERFORMANCE ANALYTICS ENGINE

(71) Applicant: Clearview Business Intelligence, LLC, Roy, UT (US)

(72) Inventors: Paul Liljenquist, Bountiful, UT (US); Benjamin Johnson, Syracuse, UT (US); John Porter, Morgan, UT (US)

(21) Appl. No.: 15/043,383

(22) Filed: Feb. 12, 2016

Related U.S. Application Data
(60) Provisional application No. 62/115,565, filed on Feb. 12, 2015.
(60) Provisional application No. 62/115,492, filed on Feb. 12, 2015.
(60) Provisional application No. 62/115,505, filed on Feb. 12, 2015.
(60) Provisional application No. 62/115,518, filed on Feb. 12, 2015.

(51) Int. Cl. G06Q 10/06

(52) U.S. Cl. CPC G06Q 10/06393

(57) ABSTRACT

For a performance analytics engine, a method defines a performance rule. The performance rule includes one or more Key Performance Indicator (KPI) components and one or more KPI qualifiers. Each KPI component includes one or more of a payout, a payout range, a payout rank, a payout top percentage, and a tiered payout. Each KPI qualifier includes one or more of a range qualifier, a top percentage qualifier, and a rank qualifier. The method further calculates a performance score from the performance rule.

### CROSS-REFERENCE TO RELATED APPLICATIONS

This application claims priority to U.S. Provisional Application 62/115,565 entitled “AUTOMATICALLY ROUTING A CALL USING A REAL-TIME GLOBAL RANKIING” and filed on Feb. 12, 2015 for Paul Liljenquist, which is incorporated herein by reference, U.S. Provisional Application 62/115,492 entitled “CALL CENTER MANAGEMENT LEARNING” and filed on Feb. 12, 2015 for Paul Liljenquist, which is incorporated herein by reference, U.S. Provisional Application 62/115,505 entitled “AGENT INCENTIVE MANAGEMENT” and filed on Feb. 12, 2015 for Paul Liljenquist, and U.S. Provisional Application 62/115,518 entitled “THIRD-PARTY GAME INCENTIVES” and filed on Feb. 12, 2015 for Paul Liljenquist.

### BACKGROUND

1. Field

The subject matter disclosed herein relates to a performance analytics engine.

2. Description of the Related Art

Call centers interact with large numbers of customers and originate substantial commerce. Small modifications in call center operations can have enormous effects on the profitability of the call center.

### BRIEF SUMMARY

A method for a performance analytics engine is disclosed. The method defines a performance rule. The performance rule includes one or more Key Performance Indicator (KPI) components and one or more KPI qualifiers. Each KPI component includes one or more of a payout, a payout range, a payout rank, a payout top percentage, and a tiered payout. Each KPI qualifier includes one or more of a range qualifier, a top percentage qualifier, and a rank qualifier. The method further calculates a performance score from the performance rule.

### BRIEF DESCRIPTION OF THE DRAWINGS

In order that the advantages of the embodiments of the invention will be readily understood, a more particular description of the embodiments briefly described above will be rendered by reference to specific embodiments that are illustrated in the appended drawings. Understanding that these drawings depict only some embodiments and are not therefore to be considered to be limiting of scope, the embodiments will be described and explained with additional specificity and detail through the use of the accompanying drawings, in which:

FIG. 1 is a schematic block diagram illustrating one embodiment of a call center system;

FIG. 2 is a drawing illustrating one embodiment of a workstation;

FIG. 3 is a schematic block diagram illustrating one embodiment of a computer;

FIG. 4 is a schematic block diagram illustrating one embodiment of a processing apparatus;

FIG. 5 is a schematic block diagram illustrating one embodiment of databases;

FIG. 6 is a schematic block diagram illustrating one embodiment of a user database;

FIG. 7 is a schematic block diagram illustrating one embodiment of a monitoring database;

FIG. 8 is a schematic block diagram illustrating one embodiment of a call system database;

FIG. 9 is a schematic block diagram illustrating one embodiment of a CRM database;

FIG. 10 is a schematic flow chart diagram illustrating one embodiment of a call center data processing method;

FIG. 11 is a drawing illustrating one embodiment of a dashboard;

FIG. 12 is a drawing illustrating one alternate embodiment of a dashboard;

FIG. 13 is a drawing illustrating one alternate embodiment of a dashboard;

FIG. 14 is a drawing illustrating one embodiment of a dashboard with monitoring data;

FIG. 15 is a drawing illustrating one embodiment of a dashboard with performance objectives;

FIG. 16 is a drawing illustrating one embodiment of a dashboard gauge metrics;

FIG. 17 is a drawing illustrating one embodiment of a dashboard with a scheduling function;

FIGS. 18A-C are schematic block diagrams illustrating embodiments of organizational units;

FIG. 19A is a schematic block diagram illustrating one embodiment of an organizational unit database;

FIG. 19B is a schematic block diagram illustrating one embodiment of an organizational unit entry;

FIG. 19C is a schematic block diagram illustrating one embodiment of a performance objective;

FIG. 19D is a schematic block diagram illustrating one embodiment of a performance rule;

FIG. 19E is drawing illustrating one embodiment of rank calculation;

FIG. 19F is a drawing illustrating one embodiment of range calculation;

FIG. 19G is a drawing illustrating one embodiment of percentage calculation;

FIG. 19H is a drawing illustrating one embodiment of tiered calculation;

FIG. 19I is a schematic block diagram illustrating one embodiment of performance data;

FIG. 20A is a schematic flowchart diagrams illustrating one embodiment of a performance score calculation method;

FIG. 20B is a schematic flow chart diagram illustrating one embodiment of a routing method;

FIG. 21A is a schematic block diagram illustrating one embodiment of learning data;

FIG. 21B is a schematic block diagram illustrating one embodiment of training event data;

FIG. 22A is a schematic flowchart diagrams illustrating one embodiment of a learning management method;

FIG. 22B is a schematic flowchart diagrams illustrating one alternate embodiment of a learning management method;

FIG. 23A is a schematic block diagram illustrating one embodiment of an incentive system;

FIG. 23B is a schematic block diagram illustrating one alternate embodiment of an incentive system;

FIG. 24A is a schematic block diagram illustrating one embodiment of a point packet;

FIG. 24B is a schematic block diagram illustrating one embodiment of a game packet; and

FIG. 25 is a schematic flow chart diagram illustrating one embodiment of a game incentive method.

### DETAILED DESCRIPTION

As will be appreciated by one skilled in the art, aspects of the embodiments may be embodied as a system, method or program product. Accordingly, embodiments may take the form of an entirely hardware embodiment, an entirely software embodiment (including firmware, resident software, micro-code, etc.) or an embodiment combining software and hardware aspects that may all generally be referred to herein as a “circuit,” “module” or “system.” Furthermore, embodiments may take the form of a program product embodied in one or more computer readable storage devices storing machine readable code, computer readable code, and/or program code, referred hereafter as code. The storage devices may be tangible, non-transitory, and/or non-transmission. The storage devices may not embody signals. In a certain embodiment, the storage devices only employ signals for accessing code.

Many of the functional units described in this specification have been labeled as modules, in order to more particularly emphasize their implementation independence. For example, a module may be implemented as a hardware circuit comprising custom VLSI circuits or gate arrays, off-the-shelf semiconductors such as logic chips, transistors, or other discrete components. A module may also be implemented in programmable hardware devices such as field programmable gate arrays, programmable array logic, programmable logic devices or the like.

Modules may also be implemented in code and/or software for execution by various types of processors. An identified module of code may, for instance, comprise one or more physical or logical blocks of executable code which may, for instance, be organized as an object, procedure, or function. Nevertheless, the executables of an identified module need not be physically located together, but may comprise disparate instructions stored in different locations which, when joined logically together, comprise the module and achieve the stated purpose for the module.

Indeed, a module of code may be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different computer readable storage devices. Where a module or portions of a module are implemented in software, the software portions are stored on one or more computer readable storage devices.

Any combination of one or more computer readable medium may be utilized. The computer readable medium may be a computer readable storage medium. The computer readable storage medium may be a storage device storing the code. The storage device may be, for example, but not limited to, an electronic, magnetic, optical, electromagnetic, infrared, holographic, micromechanical, or semiconductor system, apparatus, or device, or any suitable combination of the foregoing.

More specific examples (a non-exhaustive list) of the storage device would include the following: an electrical connection having one or more wires, a portable computer diskette, a hard disk, a random access memory (RAM), a read-only memory (ROM), an erasable programmable read-only memory (EPROM or Flash memory), a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Code for carrying out operations for embodiments may be written in any combination of one or more programming languages including an object oriented programming language such as Python, Ruby, Java, Smalltalk, C++, or the like, and conventional procedural programming languages, such as the “C” programming language, or the like, and/or machine languages such as assembly languages. The code may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Reference throughout this specification to “one embodiment,” “an embodiment,” or similar language means that a particular feature, structure, or characteristic described in connection with the embodiment is included in at least one embodiment. Thus, appearances of the phrases “in one embodiment,” “in an embodiment,” and similar language throughout this specification may, but do not necessarily, all refer to the same embodiment, but mean “one or more but not all embodiments” unless expressly specified otherwise. The terms “including,” “comprising,” “having,” and variations thereof mean “including but not limited to,” unless expressly specified otherwise. An enumerated listing of items does not imply that any or all of the items are mutually exclusive, unless expressly specified otherwise. The terms “a,” “an,” and “the” also refer to “one or more” unless expressly specified otherwise.

Furthermore, the described features, structures, or characteristics of the embodiments may be combined in any suitable manner. In the following description, numerous specific details are provided, such as examples of programming, software modules, user selections, network transactions, database queries, database structures, hardware modules, hardware circuits, hardware chips, etc., to provide a thorough understanding of embodiments. One skilled in the relevant art will recognize, however, that embodiments may be practiced without one or more of the specific details, or with other methods, components, materials, and so forth. In other instances, well-known structures, materials, or operations are not shown or described in detail to avoid obscuring aspects of an embodiment.

Aspects of the embodiments are described below with reference to schematic flowchart diagrams and/or schematic block diagrams of methods, apparatuses, systems, and program products according to embodiments. It will be understood that each block of the schematic flowchart diagrams and/or schematic block diagrams, and combinations of blocks in the schematic flowchart diagrams and/or schematic block diagrams, can be implemented by code. These code may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the schematic flowchart diagrams and/or schematic block diagrams block or blocks.

The code may also be stored in a storage device that can direct a computer, other programmable data processing apparatus, or other devices to function in a particular manner, such that the instructions stored in the storage device produce an article of manufacture including instructions which implement the function/act specified in the schematic flowchart diagrams and/or schematic block diagrams block or blocks.

The code may also be loaded onto a computer, other programmable data processing apparatus, or other devices to cause a series of operational steps to be performed on the computer, other programmable apparatus or other devices to produce a computer implemented process such that the code which execute on the computer or other programmable apparatus provide processes for implementing the functions/acts specified in the flowchart and/or block diagram block or blocks.

The schematic flowchart diagrams and/or schematic block diagrams in the Figures illustrate the architecture, functionality, and operation of possible implementations of apparatuses, systems, methods and program products according to various embodiments. In this regard, each block in the schematic flowchart diagrams and/or schematic block diagrams may represent a module, segment, or portion of code, which comprises one or more executable instructions of the code for implementing the specified logical function(s).

It should also be noted that, in some alternative implementations, the functions noted in the block may occur out of the order noted in the Figures. For example, two blocks shown in succession may, in fact, be executed substantially concurrently, or the blocks may sometimes be executed in the reverse order, depending upon the functionality involved. Other steps and methods may be conceived that are equivalent in function, logic, or effect to one or more blocks, or portions thereof, of the illustrated Figures.

Although various arrow types and line types may be employed in the flowchart and/or block diagrams, they are understood not to limit the scope of the corresponding embodiments. Indeed, some arrows or other connectors may be used to indicate only the logical flow of the depicted embodiment. For instance, an arrow may indicate a waiting or monitoring period of unspecified duration between enumerated steps of the depicted embodiment. It will also be noted that each block of the block diagrams and/or flowchart diagrams, and combinations of blocks in the block diagrams and/or flowchart diagrams, can be implemented by special purpose hardware-based systems that perform the specified functions or acts, or combinations of special purpose hardware and code.

The description of elements in each figure may refer to elements of proceeding figures. Like numbers refer to like elements in all figures, including alternate embodiments of like elements.

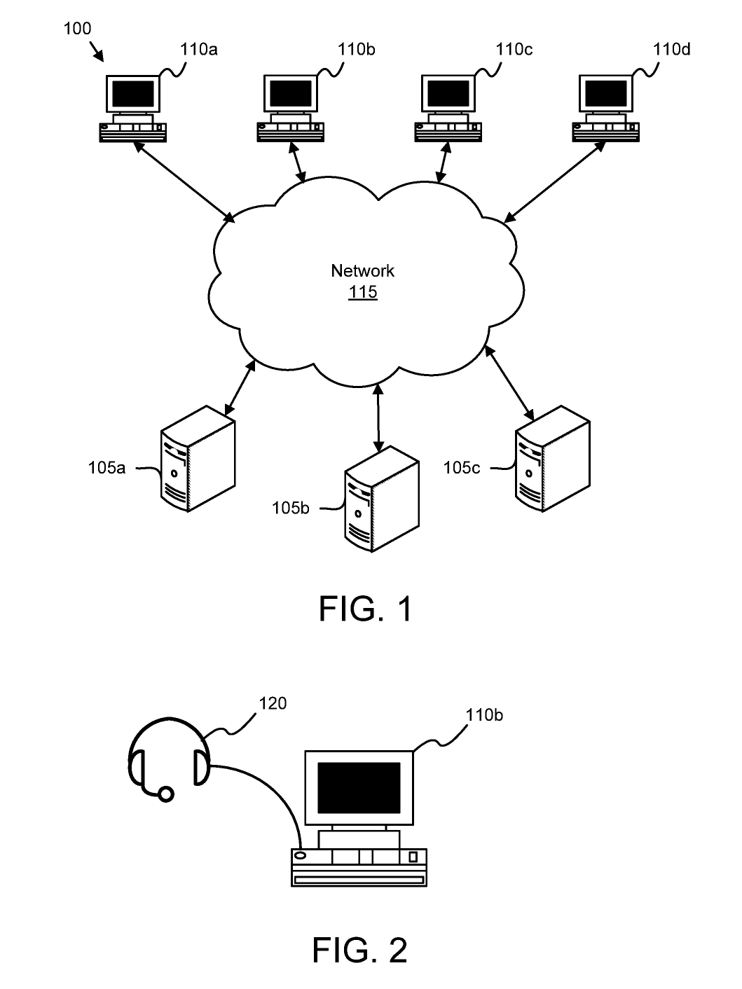

FIG. 1 is a schematic block diagram illustrating one embodiment of a call center system 100. The system 100 includes one or more workstations 110, a network 115, and one or more servers 105. Users may employ the workstations 110 in placing and receiving telephone calls. A user may be an agent, an operator, or the like. The workstations 110 may provide customer information as will be described hereafter. The workstations 110 may receive the customer information over the network 115 from the servers 105. In addition, the workstations 110 may provide information over the network 115 to the servers 105.

In one embodiment, the network 115 provides telephonic communications for the workstations 100. The telephonic communications may be over a voice over Internet protocol, telephone land lines, or the like. The network 115 may include the Internet, a wide-area network, a local area network, or combinations thereof.

The servers 105 may store one or more databases. The databases may be employed by the users as will be described hereafter. The servers 105 may be one or more discrete servers, blade servers, a server farm, a mainframe computer, or combinations thereof.

FIG. 2 is a drawing illustrating one embodiment of a workstation 110. The workstation 110 is the workstation 110 of FIG. 1. The workstation 110 is depicted with a headset 120. The user may communicate audibly through the headset 120. The workstation 110 may allow the user to input data such as a customer address, purchase preferences, credit card information, or the like. In addition, the workstation 110 may display information such as a customer name, purchase history, and the like.

In one embodiment, a workstation 110 is employed by an administrator. The administrator may employ the workstation 110 and one or more servers 105 to process and display call-center data. In the past, the call-center data was provided as discrete information from a database. The embodiments described herein process the call-center data and display the data to increase the effectiveness of administrator in managing the call-center as will be described hereafter.

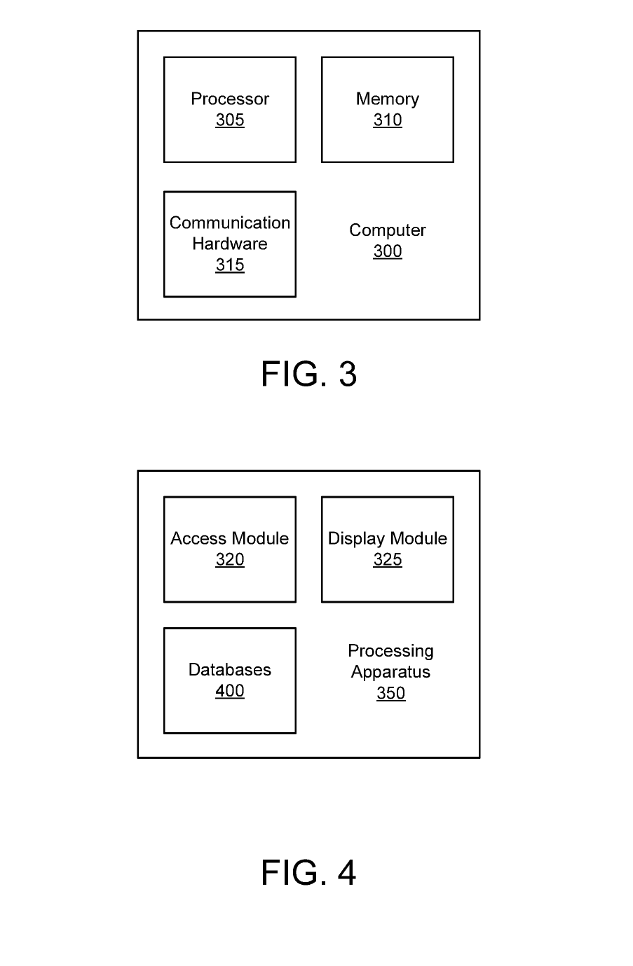

FIG. 3 is a schematic block diagram illustrating one embodiment of a computer 300. The computer 300 may be the server 105 and/or the workstation 110 of FIG. 1. The computer 300 includes a processor 305, a memory 310, and communication hardware 315. The memory 310 may be a computer readable storage medium such as a hard disk drive, an optical storage device, a micromechanical storage device, a semiconductor storage device, a holographic storage device, or combinations thereof. The memory 310 may store computer readable program code. The processor 305 may execute the computer readable program code to perform the functions of embodiments of the invention.

FIG. 4 is a schematic block diagram illustrating one embodiment of a processing apparatus 350. The apparatus 350 may be embodied in the computer 300. In addition, the apparatus 350 may be embodied in one or more servers 105, one or more workstations 110, or combinations thereof.

The apparatus 350 includes an access module 320 a display module 325, and one or more databases 400. The access module 320, the display module 325, the databases 400 may be embodied in a computer readable storage medium, such as the memory 310, storing computer readable program code. The computer readable program code may include instructions, data, or combinations thereof. The processor 305 may execute the computer readable program code.

The access module 320 may receive call system data for a plurality of users. In addition, the access module 320 may receive customer relationship management (CRM) data and receive user data for the plurality of users. The display module 325 may display the call system data, the CRM data, and the user data in a temporal relationship for a first user as dashboard data. The temporal relationship may be a specified time interval. The administrator may specify the time interval. Alternatively, the user may specify the time interval. In one embodiment, selected summary data including the call system data, CRM data, user data, monitoring data, and data calculated as functions of the call system data, CRM data, user data, monitoring data occurring within the specified time interval may be displayed in the temporal relationship.

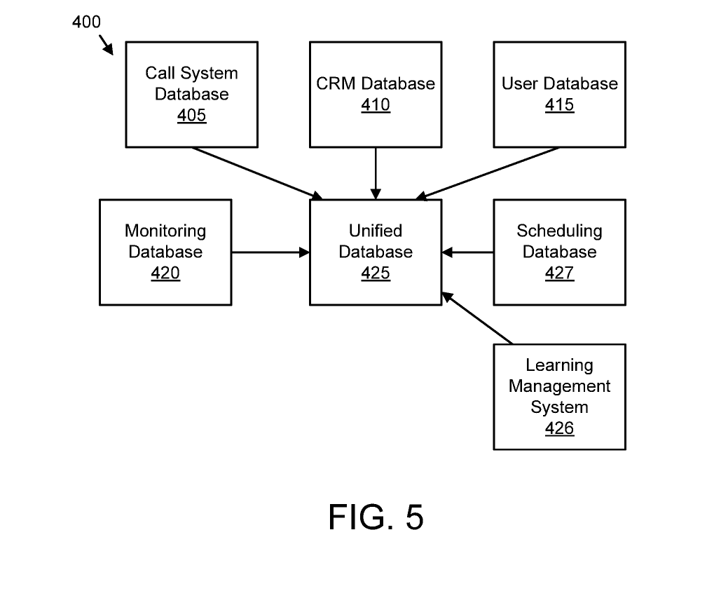

FIG. 5 is a schematic block diagram illustrating one embodiment of databases 400. The databases 400 may be stored on one or more of the servers 105 and/or storage devices in communication with the servers 105. Data from the workstations 110 may be communicated over the network 115 to the databases 400. In addition, data from the databases 400 may be provided to the workstations 110 over the network 115.

The databases 400 include a call system database 405, a CRM database 410, a user database 415, monitoring database 420, a scheduling database 427, and a learning management database 426. The databases 400 may also include a unified database 425.

Each of the databases 400 may include one or more tables, queries, structured query language (SQL) code, views, and the like. Alternatively, the databases 400 may be structured as a linked data structures, one or more flat files, or the like. The scheduling database 427 may include scheduled start times, scheduled end times, start times, and end times for the users.

In one embodiment, the access module 320 receives data from the databases 400 and stores the received data in the unified database 425. The databases 400 may communicate the data to the unified database 425 at one or more specified intervals. Alternatively, the access module 320 may query the databases 400 for the data. The access module 320 may query the databases 400 at one or more specified intervals.

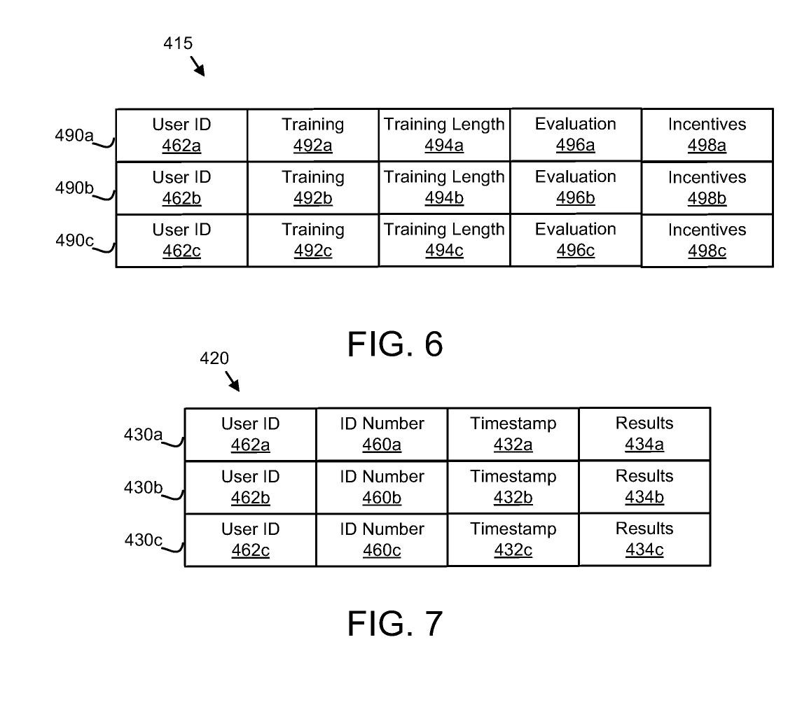

FIG. 6 is a schematic block diagram illustrating one embodiment of the user database 415. The user database 415 includes a plurality of entries 490. Each entry 490 may include a user identifier (ID) 462, training information 492, a training length 494, a training evaluation 496, and incentive information 498.

The user ID 462 may identify the user. The user ID 462 may be an employee number, a hash of an employee number, or the like. The training information 492 may record training sessions, trading modules and training module progress, management interactions, and the like referred to herein is training. The training length 494 may quantify the amount of time invested in a training by the user. For example, the training length 494 and an amount of time spent viewing a training module. The training evaluation 496 may include test scores, an instructor evaluation, a self-evaluation, course ratings, or combinations thereof. The incentive information 498 may record incentives that are offered to the user, whether an incentive was awarded, the time interval required to earn the incentive, and the like.

FIG. 7 is a schematic block diagram illustrating one embodiment of a monitoring database 420. The monitoring database 420 includes a plurality of entries 430. Each entry may include the user ID 462, an ID number 460, a timestamp 432, and results information 434. The user ID 462 may be the user ID 462 of FIG. 6. The ID number 460 may be a telephone number of a customer, a customer index number, or other number that uniquely identifies the customer. The time stamp 432 may record a time of a telephone conversation between the user and the customer. The results information 434 may record the outcome of the conversation between the user and the customer. For example, the results information 434 may record whether is the customer elected to purchase an item, upgrade service, continue using a service or product rather than canceling or returning the service or product, or the like.

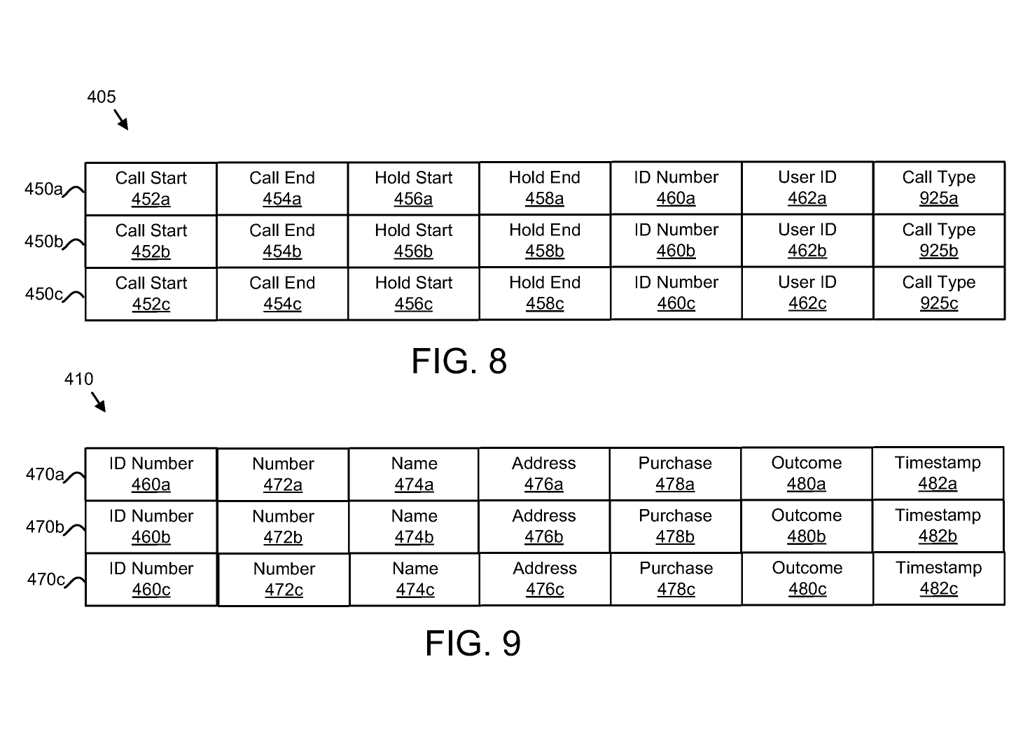

FIG. 8 is a schematic block diagram illustrating one embodiment of a call system database 405. The call system database 405 may be a custom database, a commercially licensed database, or combinations thereof. The call system database 405 may record information about a telephone conversation between the user and a customer.

The call system database 405 may include a plurality of entries 450. Each entry 450 may be generated in response to a telephone conversation, a video conversation, a text conversation, or combinations thereof. In one embodiment, each entry 450 includes a call start time 452, a call end time 454, a hold start time 456, a hold end time 458, the ID number 460, and the user ID 462.

The call start time 452 may record a time a telephone conversation begins. The call end time 454 may record when the telephone conversation terminates. The hold start time 456 may record a start of a hold interval. The hold end time 458 may record an end of the hold interval. For example, the user may put the customer on hold in order to perform a function such as consulting with the supervisor, checking on product and/or pricing and availability, and the like. The hold start time 456 may record when the hold interval started and the hold and time 458 may record when the hold interval ended. In one embodiment, each entry may include one or more call start times 452, call end times 454, hold start times 456, and hold end times 458. The ID number 460 is the ID number 460 of FIG. 7. The user ID 462 as the user ID 462 of FIGS. 6 and 7.

FIG. 9 is a schematic block diagram illustrating one embodiment of a CRM database 405. The CRM database 410 may be a custom database, a commercially licensed database, or combinations thereof. The CRM database 410 may include a plurality of entries 470. The entries 470 may include the ID number 460, a number 472, a name 474, an address 476, purchase information 478, outcome information 480, and a time stamp 482.

The ID number 460 may be the ID number 460 of FIGS. 5-7. The number 472 may be a telephone number, an email address, or other communication address. The name 474 may be the customer name. The address 476 may be the customer address.

The purchase information 478 may include all purchases by the customer. In one embodiment, the purchase information 478 references a separate table. The purchase information 478 may include purchases including product purchases, service purchases, service contracts, service information, return information, and combinations thereof. The purchase information 478 may also include product upgrades, products downgrades, product cancellations, and the like.

The outcome information 480 may record results from each conversation with the customer. The outcome information 480 may include customer comments, customer commitments, user notes, automated survey results, user survey results, and the like.

In one embodiment, the timestamp 482 records a time of each conversation with the customer. The timestamp 482 may record a plurality of times. The times recorded in the time stamp 482 may be used to identify entries in other databases 400 that correspond to entries 470 of the CRM database 410.

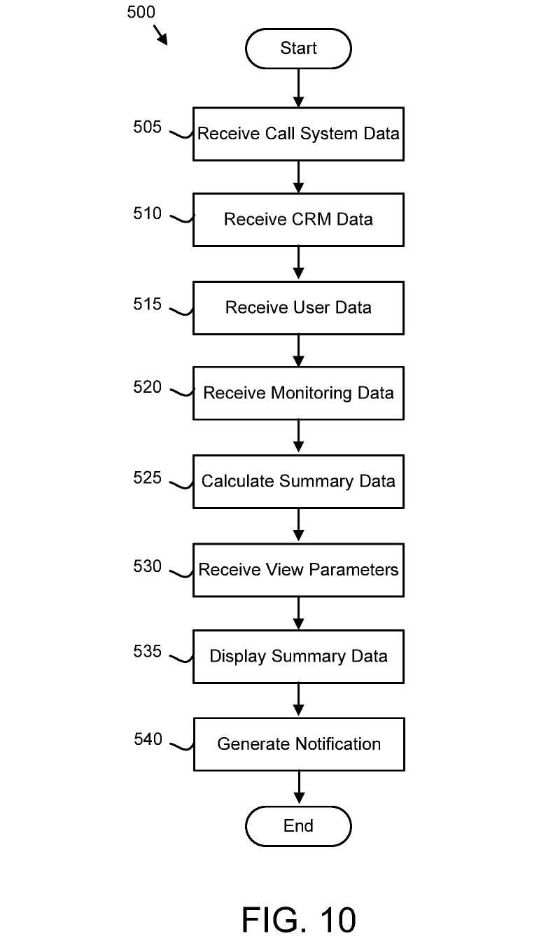

FIG. 10 is a schematic flow chart diagram illustrating one embodiment of a call center data processing method 500. The method 500 may be performed by the apparatus 350. Alternatively, the method 500 may be performed by a computer program product such as computer readable storage medium storing computer readable program code.

The method 500 starts and the access module 320 receives 505 call system data. The call system data may be received 505 from the call system database 405. In one embodiment, a server 105 storing the call system database 405 communicates the call system data to the access module 320 at specified times. Alternatively, the access module 320 may request the call system data from the server 105 and/or the call system database 405 at specified times. The specified times may include the ranges of every 1 to 10 minutes, every 10 to 30 minutes, every 30 to 90 minutes, every 4 to 12 hours, or the like.

The access module 320 may further receive 510 CRM data. The CRM data may be received 510 from the CRM database 410. In one embodiment, a server 105 storing the CRM database 410 communicates the CRM data to the access module 320 at the specified times. Alternatively, the access module 320 may request the CRM data from the server 105 and/or the CRM database 410 at the specified times.

The access module 320 may receive 515 user data. In one embodiment, a server 105 storing the user database 415 communicates the user data to the access module 320 at the specified times. Alternatively, the access module 320 a request the user data from the server 105 and/or the user database 415 at the specified times.

In one embodiment, the access module 320 receives 520 monitoring data. A server 105 storing a monitoring database 420 may communicate the monitoring data to the access module 320 at the specified times. Alternatively, the access module 320 may request a monitoring data from the server 105 and/or the monitoring database 420 at the specified times.

In one embodiment, a server 105 may execute computer readable program code that activates a timer. The timer may count down a time interval equivalent to the specified time. When the timer counts to zero, a computer readable program code may generate an interrupt and branch control to an access thread. The access thread may gather specified data from a least one of the call system database 405, the CRM database 410, the user database 415, and the monitoring database 420 and communicate the specified data to the access module 320. Alternatively, the access thread may request the specified data from at least one of call system database 405, the CRM database 410, the user database 415, and the monitoring database 420. In addition, the access thread may activate a listener that listens on one or more specified ports for the specified data.

In one embodiment, the access module 320 calculates 525 summary data from the call system data, CRM data, user data, and monitoring data. The summary data may be the call system data, CRM data, user data, and monitoring data. In addition, the summary data may comprise summary data elements that are calculated as a function of at least one other summary data element. Table 1 lists exemplary summary data elements.

TABLE 1

| Summary | |
|---|---|
| Data | Description |
| Abandons | Number of customers who hung up before speaking with |
| | an agent |
| Additional | Percentage of times an offer was made on an additional |
| product ideal | product in an ideal way |
| percentage | |
| Additional | Percentage of times an offer was made on an additional |
| product offer | product |
| percentage | |
| After Trial | Percentage of full refunds after trial period |
| Full Refund Percent | |
| Agent count | Number of users |
| Answered | Number of calls that were answered |
| AvailableTime | WaitTime + HandleTime (total time a user is available to |
| | take a call or on/closing a call) |
| Average close | Average time need to close sale |
| time | |
| Average | Average time to complete a call |
| handle time | |
| Average talk | Average time talking with customer |
| time | |
| CallCloseTime | Time to make a close calculated from call data rather |
| | than user data |
| CallHandleTime | HandleTime calculated from call data rather than user |
| | data |
| Calls | Number of calls received |
| Calls per hour | Calls per hour |
| CallsReceived | number of calls received rather than the number of calls |
| | handled (If a call goes from 10:45AM to 11:15 AM, Calls would |
| | count half the call in each hour. CallsReceived counts the entire |
| | call in the hour where it was received) |
| CallTalkTime | TalkTime that is calculated from the call data rather than |
| | user data |
| CallTime | Minutes of connected call time |
| Close Percent | Percentage of time spent on the close portion of calls |
| CloseTime | Time an agent spends filling out notes after a call ends |
| Communication | Score on communication skills evaluation |
| skills percentage | |
| Contacts | Number of calls that resulted in a contact |
| Conversation | Percentage of calls resulting in an account conversion |
| Percent | |
| Email | Percentage of follow-up emails sent |
| percentage | |
| Five-star | Percentage of five star ratings from customer evaluation |
| percentage | |
| Focus form | Score on a QA form |
| Full | Percent of full engagement evaluations |
| engagement | |
| percentage | |
| Full interview | Percentage that interview is completed. |
| percentage | |
| HandleTime | Time to complete a call |
| HeadCount | Number of users |
| Hold Percent | Percent of call time a customer is on hold |
| HoldTime | Amount time a user is on hold |
| InServiceLevel | Number of calls that were answered by an agent before |
| | the service level threshold was reached |
| Interview | Interviews as percentage of calls |
| percentage | |
| New Package | New package sales |
| New Package | Percentage of calls resulting in new package sales |
| Percent | |
| New Product | New product sales |
| New Product | Percentage of calls resulting in new product sales |
| Percent | |
| Offer | Target percentage for making an offer |
| percentage | |
| Offer rate | Rate that offer is made |
| Orders | Number of calls that resulted in a sale |
| Package ideal | Target percentage for making a package offer |
| offer percentage | |
| Package ideal | Percentage of instances a package offer is made |
| percentage | |
| Percent Hold | Percentage of time spent on hold |
| Product ideal | Percentage of instances a product offer is made in an |
| percentage | ideal way |
| Product offer | Percentage of instances a product offer is made |
| percentage | |
| QA metric | Relevant quality assurance metric |
| QueueTime | Time a customer is on hold waiting to be connected to a |
| | user |
| Recap | Recap of agreement with customer |
| Revenue | Revenue generated from a sale |
| Revenue per | Average revenue generated for each call |
| call | |
| Revenue per | Revenue per hour |
| hour | |
| Revenue per | Revenue per order |
| order | |
| RPC | Revenue per call |
| RPH | Revenue per hour |
| RPO | Revenue per order |
| Sales | Sales per user |
| Sales per hour | Sales per hour |
| Save Percent | Percentage of cancelations that are saved |
| Service level | Service level of call |
| SLACalls | Number of calls where the call was answered or the |
| | customer was on hold over a certain threshold |
| Talk percent | Percent of time spent on the phone |
| TalkTime | Amount of time a user is on the phone |
| Test | Test score |
| Test Q | Test question |
| Total revenue | Total revenue |
| TotalTime | AvailableTime + UnavailableTime (Total time a user is |
| | logged into the system) |
| Tran | Calls transferred elsewhere |
| Transfer | Percentage of calls transferred elsewhere |
| Percent | |
| Unavailable | Percentage of time user is unavailable |
| percent | |
| Unavailable | Time a user is unavailable |
| time | |
| UnavailableTime | Time a user is logged into the system but unavailable to |
| | take a call |
| Wait percent | Percentage of time user is waiting to receive a call |
| WaitTime | Time a user is waiting to receive a call |

The summary data may be stored in a unified database 425. In addition, portions of the call system data, CRM data, user data, and monitoring data may be stored in the unified database 425 as summary data. In one embodiment, the summary data is calculated 525 as the summary data is received. Alternatively, the summary data may be calculated 525 as a batch job.

In one embodiment, contacts are calculated from a number of entries 450 in the call system database 405. Call minutes may be calculated from the calls start time 452 and the call end time 454. Hold minutes may be calculated from the hold start time 456 and the hold end time 458. Total time may be calculated as call minutes plus wait minutes. Percent hold may be calculated as hold minutes divided by talk minutes. Conversion percent may be calculated as purchases 478 divided by contacts. Conversion percent may be calculated as outcomes 480 where the customer converts divided by contacts. Hold percent may be calculated as outcomes 480 where the customer maintains an account divided by contacts. Tran may be a number of calls transferred elsewhere.

New product may be calculated as purchases 478 where the customer purchases a new product. New package may be calculated as total outcomes 480 where the customer signs up for a new package. New product percentage may be calculated as new products divided by contacts. New package percentage may be calculated as new packages divided by contacts.

Revenue may be total gross revenue for a user, a team, a group, or the like. In one embodiment, RPH is calculated as total revenue per hour. RPO may be calculated as revenue per user and/or revenue per operator. RPC may be calculated as revenue per contact. SPH may be calculated as sales per hour. Sales maybe unit sales, total orders, or combinations thereof.

In one embodiment the display module 325 receives 530 view parameters. The view parameters may specify how to the display the summary data on a dashboard. The display module 325 may receive 530 the view parameters through a workstation 110 from an administrator and/or from the user. Options for view parameters will be described hereafter. The view parameters may specify a specified order for arranging dashboard data.

The display module 325 may further display 535 summary data from the unified database 425 as dashboard data in accordance with the view parameters. In one embodiment, the display module 325 displays 535 the call system data of the call system database 405, the CRM data of the CRM database 410, and the user data of the user database 415. The display module 325 may also display monitoring data from the monitoring database 420. In addition, the display module 325 may display summary data calculated as functions of the call system data, the CRM data, the user data, and the monitoring data. The display of the summary data as dashboard data will be described hereafter in more detail.

One or more summary data elements may be selected as metrics. In addition, one or more summary data elements may be selected as success rates. Targets may be selected for one or more summary data elements. In addition, a target limit may be selected for a target. A target limit may be a percentage of a target.

The display module 325 may monitor a target for at least one summary data element for at least one user. For example, the display module 325 may monitor a Close Percentage for a user. Alternatively, the display module 325 may monitor a Full engagement percentage for a team. In one embodiment, the display module 325 generates 540 a notification and the method 500 ends. The notification may be generated if a summary data element or metric satisfies a target. Alternatively, the notification may be generated if a summary data element or metric exceeds a target limit.

The notification may be displayed on the dashboard to the administrator. In an alternate embodiment, the notification is communicated through email, a phone call, or the like. Alternatively, the notification may be communicated to the user. In a certain embodiment, the notification is communicated to a team leader, floor leader, or the like.

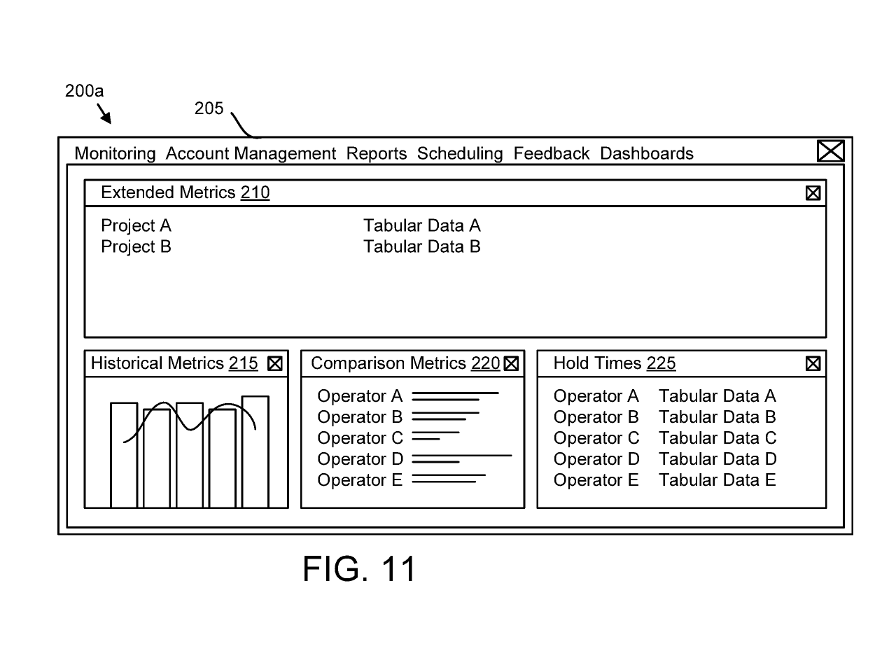

FIG. 11 is a drawing illustrating one embodiment of a dashboard 200a. Each dashboard 200a displays 535 summary data as dashboard data. An administrator and/or user may employ the dashboard 200 to manage user performance.

The dashboard 200a includes an options menu 205. In the depicted embodiment, the dashboard 200a further includes extended metrics 210. The extended metrics 210 may display summary data in a tabular form. In the depicted embodiment, summary data for a plurality of projects is displayed as tabular data, graphical data including bar charts, line charts, pie charts, histograms, graphical data, or the like. Cumulative project data may also be displayed. The tabular data may include a success rate.

In one embodiment, the dashboard 200a displays historical metrics 215. Historical metrics 215 may display summary data for one or more time intervals. Time intervals may be an hour, a shift, a day, a week, a month, a quarter, a year, or the like. The historical metrics 215 may be displayed as tabular data, bar charts, line charts, pie charts, histograms, graphical data, or the like.

The dashboard 200a may also display comparison metrics 220. The comparison metrics 220 may compare one or more summary data elements for users, team, a group, or the like. The summary data elements may be compared as graphs, tabular data, gauges, or the like.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

In one embodiment, the dashboard 200a displays hold times 225. The hold times 225 may be displayed by user team, group, or the like. The hold times 225 may be displayed as tabular data, graphical data, gauges, or the like.

In one embodiment, the dashboard 200a displays summary data organized for a least two projects and cumulative project data for lease two projects. In addition, the dashboard 200a may display dashboard data for the plurality of users organized in at least one hierarchical level.

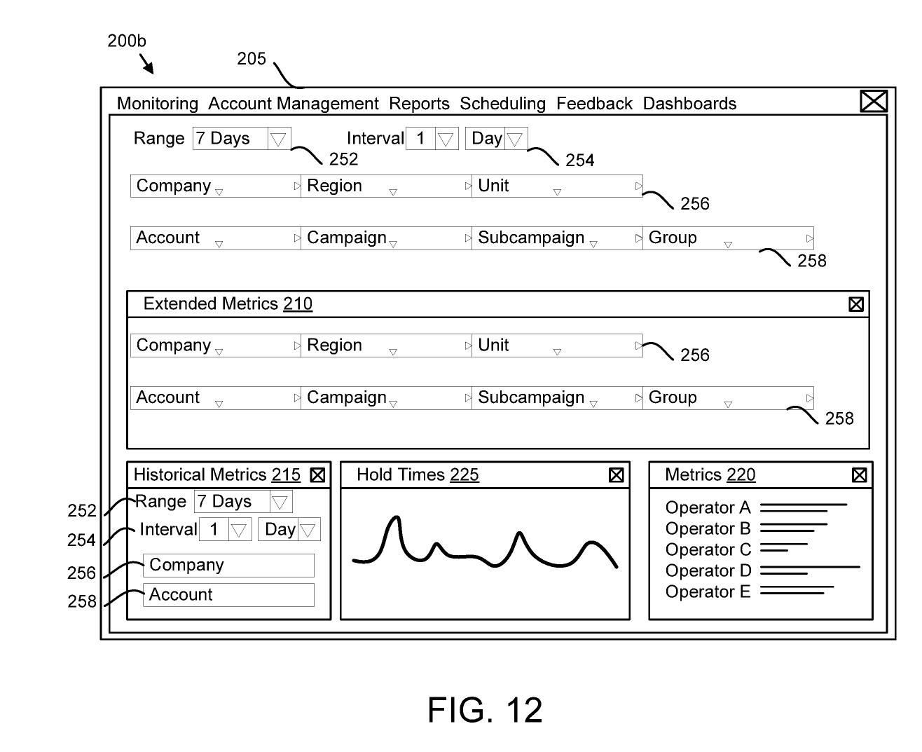

FIG. 12 is a drawing illustrating one alternate embodiment of a dashboard 200b. The dashboard 200b is depicted as receiving the view parameters. The view parameters may include a time range 252, a time interval 254, and an entity 256. The entity 256 may include entries for a company or client, a region, and a unit. The view parameters may also include account information 258. The account information 258 may include an account, a campaign, a subcampaign, and a group. The account may be a billing account. The campaign may be a sales campaign for the account. The subcampaign may be a portion of the campaign. The group may be a group of users, a group within the account, or the like.

In one embodiment, the view parameters may be further refined for specified metrics. In the depicted embodiment, the view parameters are refined for the extended metrics 210, the hold time 225, and the comparison metrics 220. In one embodiment, view parameters may be set for a specific display such as the historical metrics 215. For example in response to an administrator command such as the selection of a button or right-click, a metric display such as the historical metrics 215 may allow the administrator and/or user to modify and save view parameters such as the time range 252, the time interval 254, the entity 256, and the account 258.

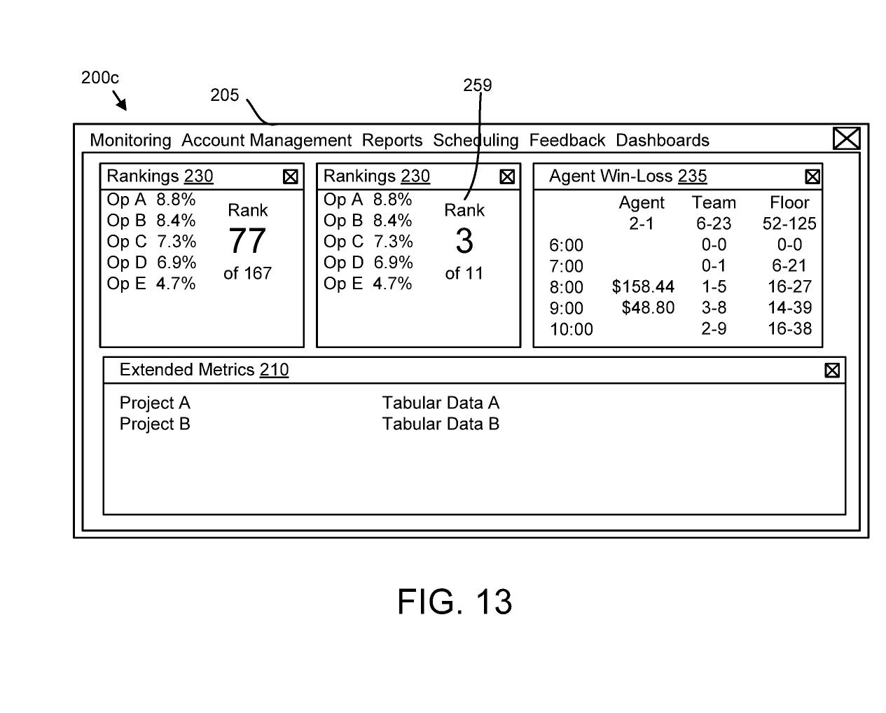

FIG. 13 is a drawing illustrating one alternate embodiment of a dashboard 200c. The dashboard 200c is depicted as displaying summary data including rankings 230, agent win-loss metrics 235, and extended metrics 210. The rankings 230 and agent win-loss metrics 235 may be displayed in tabular form, graphical form, as a gauge, or combinations thereof. In one embodiment, a detailed summary ranking 259 for a user, team, group, or the like is displayed. The detailed summary may be a success rate. The summary data may be organized for a plurality of users in at least one hierarchical level such as a team, a group, or the like.

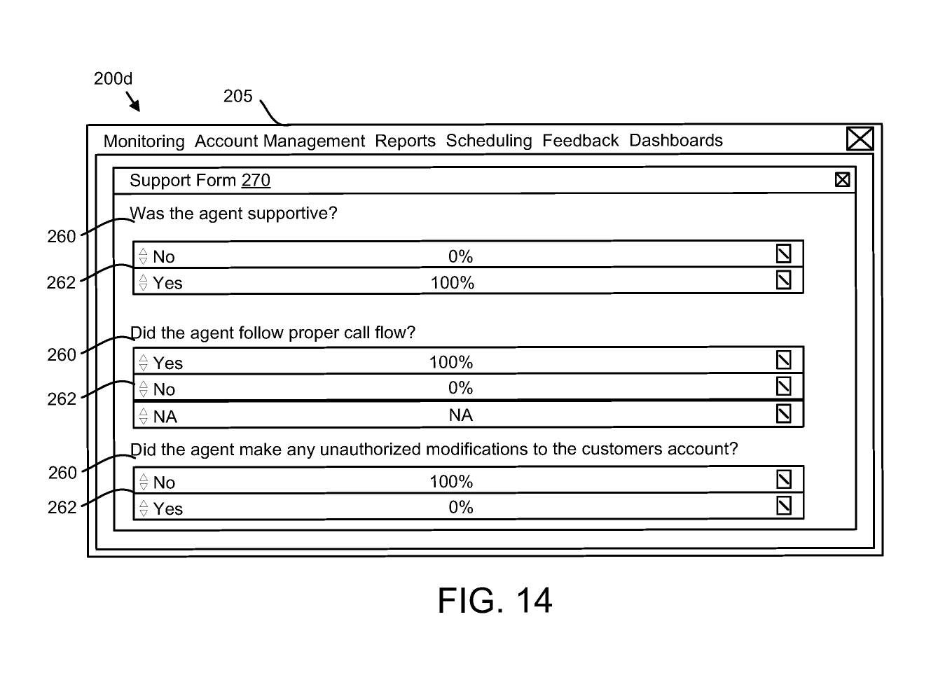

FIG. 14 is a drawing illustrating one embodiment of a dashboard 200d receiving monitoring data. In the depicted embodiment, the monitoring data is collected through a support form 200d. The support form 200d includes one or more questions 260 and one or more responses 262. An administrator, supervisor, observer, or the like may enter the responses 262. In one embodiment, an administrator may enter the responses 262 after listening to a conversation between a user and the customer. The monitoring data may be stored in the monitoring database 420.

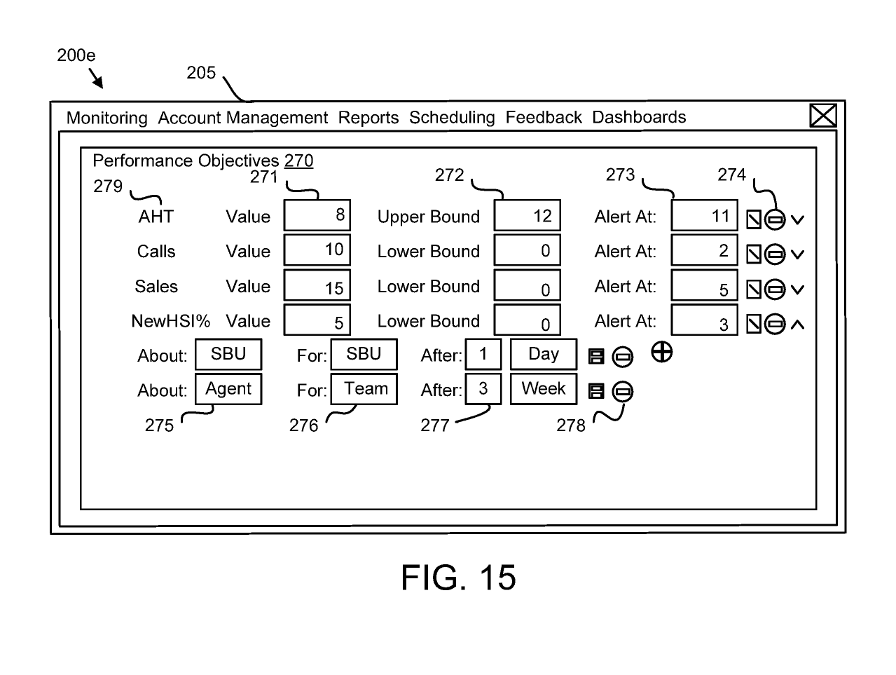

FIG. 15 is a drawing illustrating one embodiment of a dashboard 200e receiving performance objectives 270. The performance objectives 270 may include a performance target 279, a target value 271, performance target performance target bounds 272, a performance target limit 273, and controls 274. The performance target 279 may be a performance objective for a summary data element and/or metric. The performance target bounds 272 may be an upper bound or lower bound for the performance target 279. The performance target limit 273 may indicate a threshold for generating a notification. The access module 320 may generate a notification in response to performance exceeding a performance target limit 273. The controls 274 may be used to edit performance objectives 270, delete performance objectives 270, or reorder the performance objectives 270.

In one embodiment the performance objectives 270 may be modified at a future time. An administrator may select a performance objective 270 and select an evaluation level 275 of a hierarchy such as a user, team, or group for which the performance objective 270 is calculated, a notification level 276 of management that receives an alert for the performance objective 270, and a modification time 277 modifying the performance objective 270. Modification controls 278 may save and/or delete the modifications.

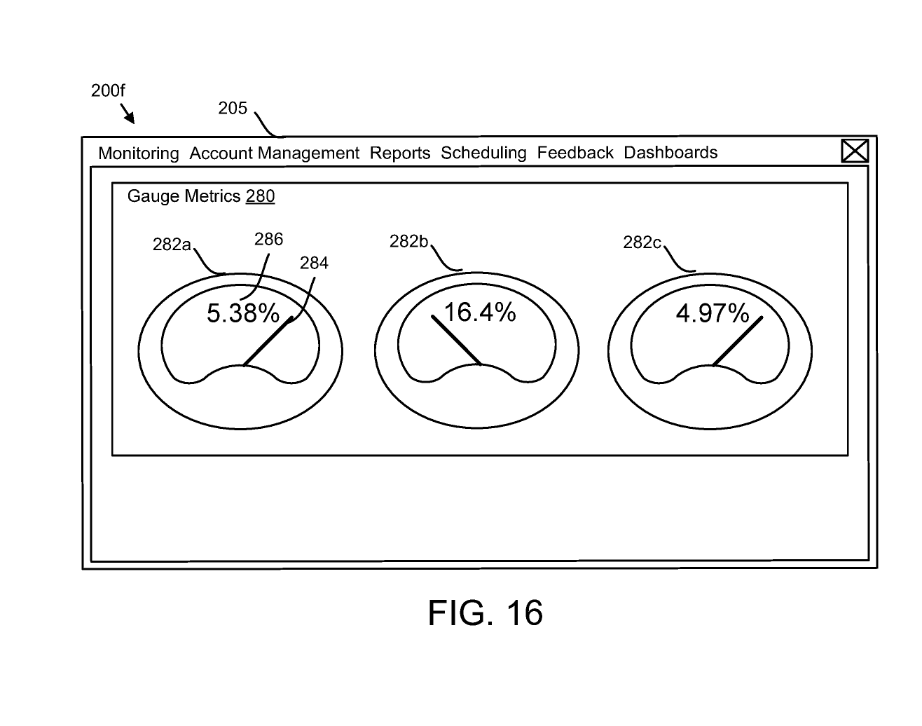

FIG. 16 is a drawing illustrating one embodiment of a dashboard 200f with gauge metrics. Specified summary data elements are displayed as data on gauges 282. Each gauge 282 may include metric needle 284 and a metric value 286. The metric needle 284 may display a summary data element with respect to an upper bound of a lower bound. The metric value 286 may display an actual value of the summary data element.

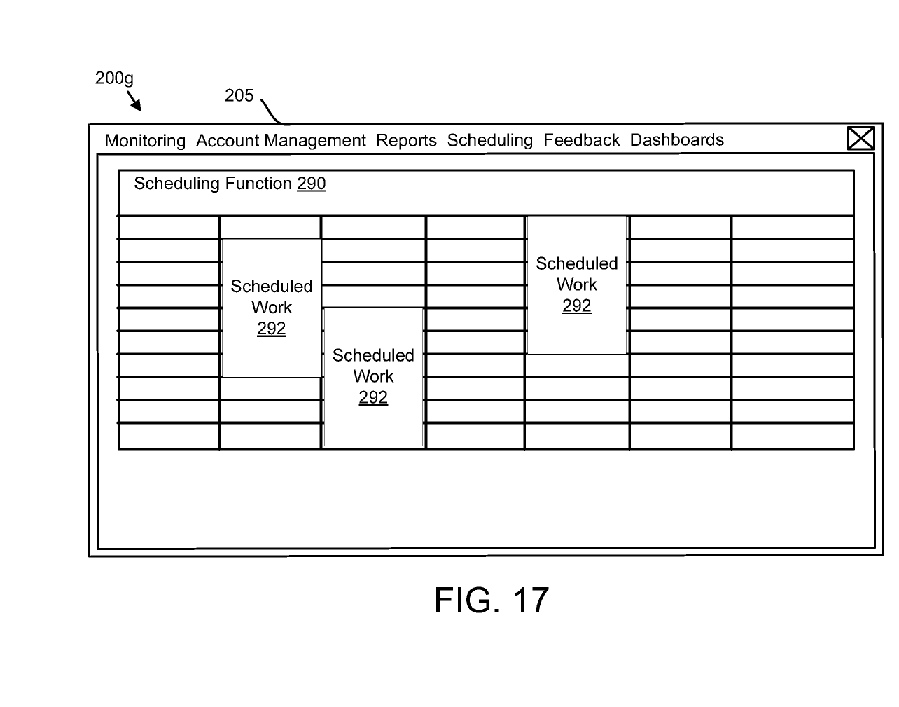

FIG. 17 is a drawing illustrating one embodiment of a dashboard 200g with a scheduling function 290. The administrator may employ the scheduling function 290 to schedule work for a user by designating scheduled work 292 for the user. The scheduled work 292 may include the scheduled start times and scheduled end times of the scheduling database 427. The user may also employ the scheduling function to view the scheduled work 292. In a certain embodiment, the user may indicate available work times through the scheduling function 290.

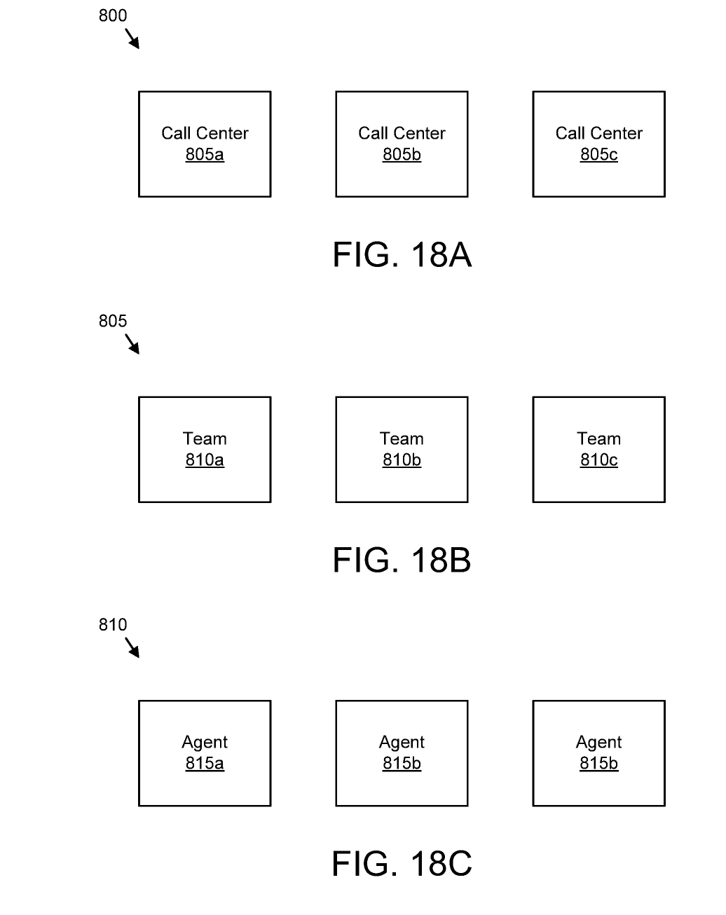

FIGS. 18A-C are schematic block diagrams illustrating embodiments of organizational units. The organizational units include an organization 800, call centers 805, teams, 810, and agents 815. FIG. 2A depicts an organization 800. The organization 800 includes one or more call centers 805. FIG. 2B depicts a call center 805. The call center 805 may include one or more teams 810. FIG. 2C depicts a team 810. The team 810 may include one or more agents 815. One of skill in the art will recognize that the embodiments may be practiced with additional hierarchical levels, organization units, relationships between the organization units, and the like.

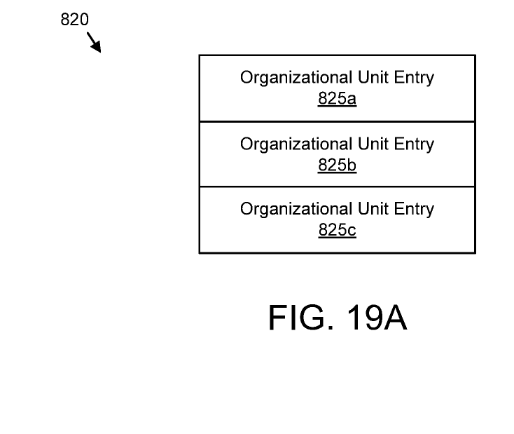

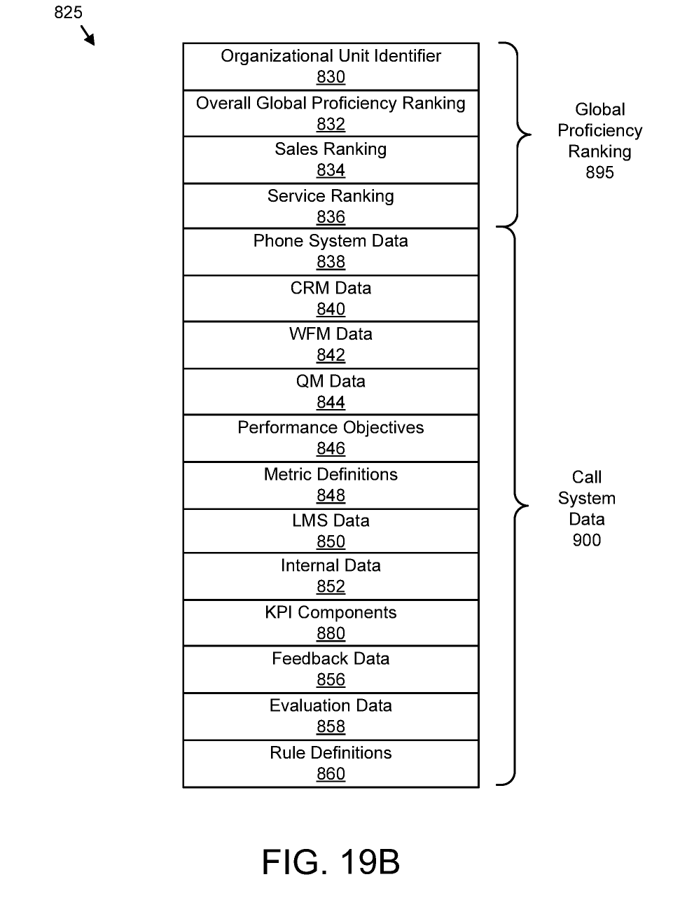

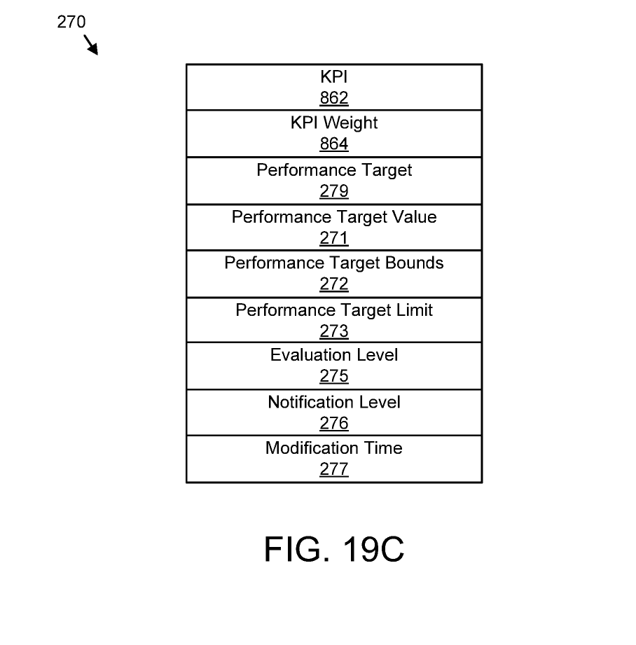

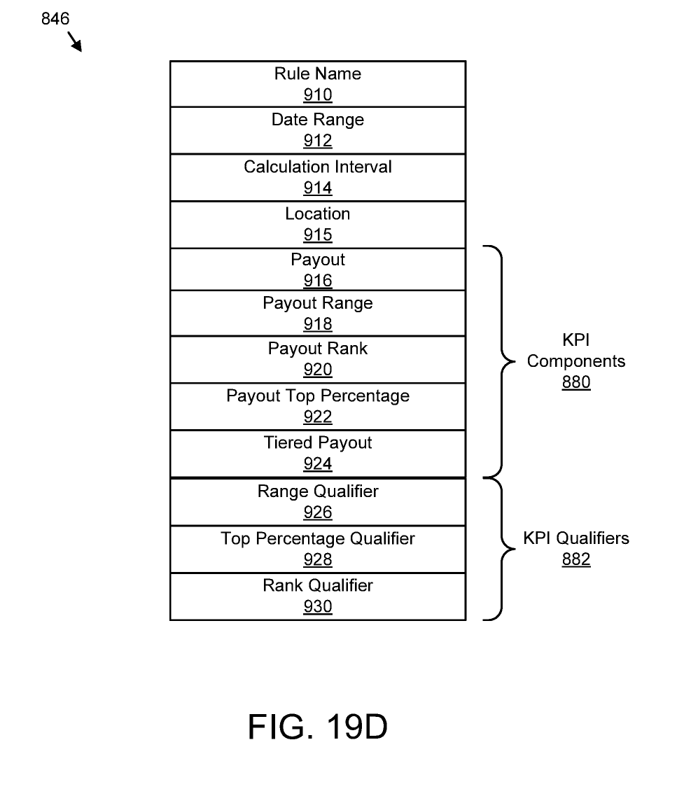

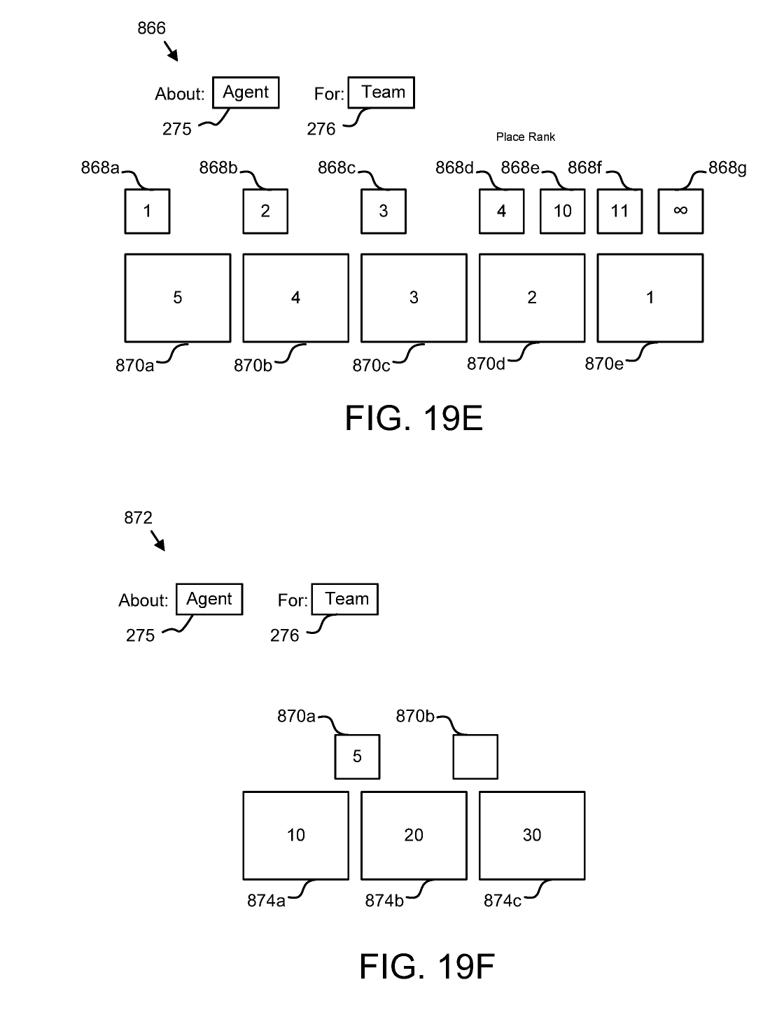

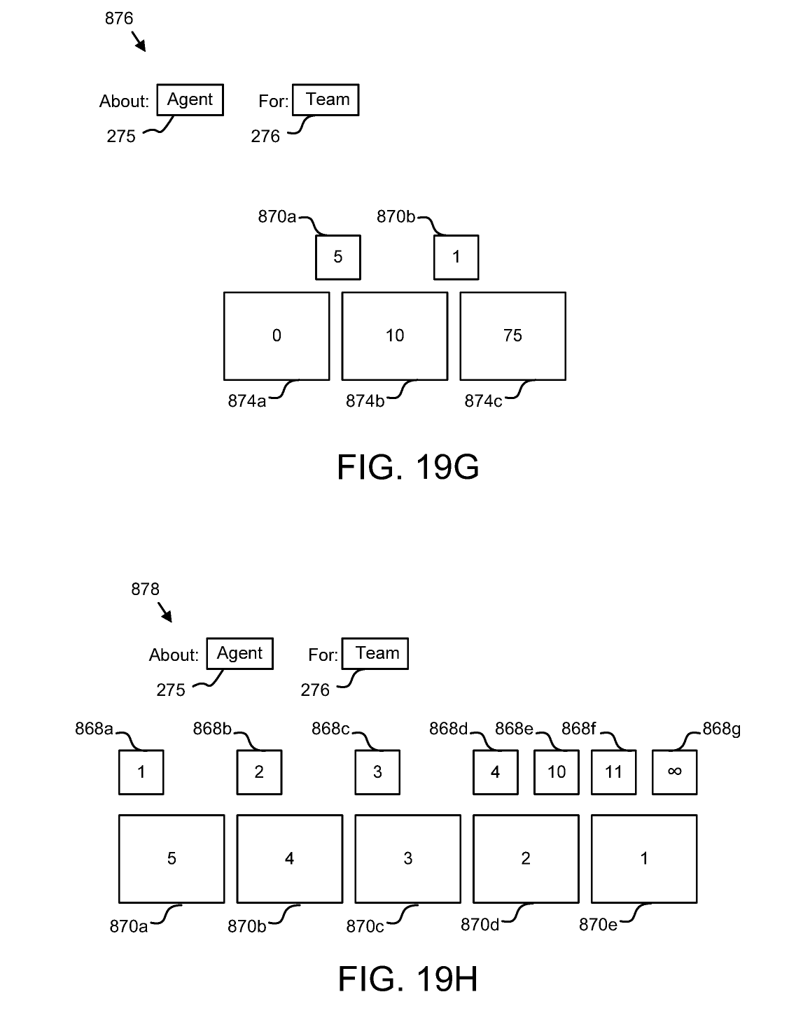

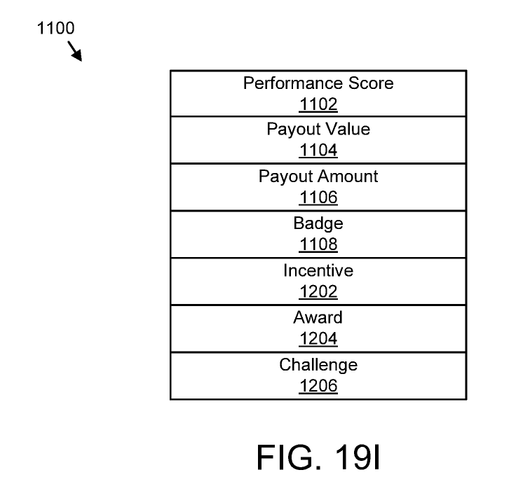

FIG. 19A is a schematic block diagram illustrating one embodiment of a call system database 820. The call system database 820 includes organizational unit entries 825 for one or more organization units. In one embodiment, the database 820 includes entries 825 for each organizational unit. For example, each agent 815 may have an entry 825. In addition, each team 810 may have an entry 825 comprising summary data for the team 810 from each agent 815 on the team 810. Similarly, each call center 805 and organization 800 may have entries comprising summary data for each agent 815 and/or team 810 in the call center 805 and/or organization 800.

FIG. 19B is a schematic block diagram illustrating one embodiment of an organizational unit entry 825. The entry 825 includes an organizational unit identifier 830 for an organizational unit, an overall global proficiency ranking 895 for the organizational unit, a sales ranking 834 for the organizational unit, a service ranking 836 for the organizational unit, the phone system data 838 for the organizational unit, workforce management (WFM) data 842 for the organizational unit, quality management (QM) data 844 for the organizational unit, learning management system (LMS) data 870 for the organizational unit, the internal data 875 for the organizational unit, KPI components 880 for the organizational unit, feedback data 885 for the organizational unit, and evaluation data 890 for the organizational unit.

The overall global ranking 845 may be a function of the sales ranking 834, the service ranking 836, and other data. The global ranking 895 may comprise the overall global proficiency ranking 895, the sales ranking 834, and the service ranking 836. The call system data 900 may comprise the phone system data 838, the CRM data 840, the WFM data 842, the QM data 844, the LMS data 870, and the internal data 875.

The KPI components 880 are described hereafter in FIG. 19D. The KPI components 880 may also describe an outcome for a communication. The outcome may be a sale, an upgrade, a problem resolution status, a service rating, or the like. The feedback data 885 may include feedback from a customer such as from a survey, a follow-up email response, of the like. The evaluation data 890 may include an evaluation from an auditor, a supervisor, or the like. Call system data 900 may comprise the KPI components 880, feedback data 885, and evaluation data 890.

FIG. 19C is a schematic block diagram illustrating one embodiment of a performance objective 270. The performance objective 270 may be organized as a data structure in a memory 310. In the depicted embodiment, the performance objectives 270 includes one or more Key Performance Indicators (KPI) 862, one or more KPI weights 864, a performance target 279, a performance target value 271, performance target bounds 272, a performance target limit 273, the evaluation level 275, the notification level 276, and the modification time 277.

Each KPI 862 may specify a performance metric that is measured. The KPI weight 864 may specify a weight that is assigned to each KPI 862. The performance target 279 may specify the desired level of performance for each KPI 862. The performance target value 271 may specify a value that is associated with achieving the performance target 279.

The performance target bounds 272 may specify an upper bound and a lower bound for the performance target 279. The performance target limit 273 may indicate a threshold for generating a notification.

The evaluation level 275 may specify an organizational level at which performance is evaluated. The notification level 276 may specify a level of management that receives a notification. The modification time 277 may modify the performance objective 270.

FIG. 19D is a schematic block diagram illustrating one embodiment of a performance rule 846. The performance rule 846 maybe organizes a data structure in the memory 310. In the depicted embodiment, the performance rule 846 includes a rule name 910, a date range 912, the calculation interval 914, a location 915, a payout 916, a payout range 918, a payout rank 920, a payout top percentage 922, a tiered payout 924, a range qualifier 926, a top percentage qualifier 928, and a rank qualifier 930. In one embodiment, the payout 916, payout range 918, payout rank 920, top payout percentage 922, and tiered payout 924 comprise KPI components 880. Payouts may be points awarded from a rule that actions may be based on, monetary compensation, rewards, or the like. The KPI components may also include the CRM data 840, the WFM data 842, the QM data 844, the LMS data 870, and the internal data 875. In one embodiment, the KPI components 880 also include the feedback data 856, the evaluation data 858, and the rule definitions 860. In a certain embodiment, the KPI components 880 include the elements of Table 1. In addition, the range qualifier 926, top percentage qualifier 928, and rank qualifier 930 may comprise KPI qualifiers 882.

The rule name 910 may uniquely identify the performance rule 846. The date range 912 may specify a range of dates when the performance rule 846 is valid. The calculation interval 914 may specify a frequency of recalculating the performance rule 846. The location 915 may specify one or more locations where the performance rule 846 is valid.

The payout 916 specifies a multiplier and a corresponding performance metric. For example, the multiplier may be one and the performance metric may be sales. If three sales are recorded, the payout 916 may be calculated as three points.

The payout range 918 may specify a number of points that are awarded when an associated performance metric falls within one or more ranges. For example, the payout range 918 may include a range of 7 to 10 that is associated with three points. If a performance metric falls within the range of 7 to 10, the value of the payout range 918 may be three points.

The payout rank 920 may specify points that are awarded based on a sequential ranking for an associated performance metric. For example, a first rank may receive 10 points while a second rank may receive eight points.

The payout top percentage 922 may specify one or more percentage ranges and associated point values for one or more performance metrics. For example, a top 6 to 10% may be awarded five points.

The tiered payout 924 may specify a multiplier for one or more numerical tiers of a performance metric. For example, the tiered payout 924 may specify awarding one point for every sale between one and three sales, and 1.2 points for every sale between four and six sales.

The range qualifier 926 may specify a range of eligibility for receiving points for one or more performance metrics. For example, if the range qualifier 926 is 15 or more sales, points may only be awarded when sales equal or exceed 15.

The top percentage qualifier 928 may specify an uppermost percentage of organizational units that are eligible to receive points for the performance metric. For example, the top percentage qualifier 928 may specify that the top 20% of the organizational units are eligible to receive points.

The rank qualifier 930 may specify one or more rank positions of organizational units that are eligible to receive points for the performance metric. For example, the rank qualifier 930 may specify that ranks one through 10 are eligible to receive points.

FIG. 19E is drawing illustrating one embodiment of rank calculation 872. The rank calculation 866 may be displayed on a screen. In the depicted embodiment, the rank calculation 866 includes an evaluation level 275 that indicates that the rank calculation 866 is made for an agent 815 with a notification level 276 of a team 810. Calculating values 870a-e are assigned for each rank 868a-g. For example, a calculating value 870a of five awarded for rank one 868a.

FIG. 19F is a drawing illustrating one embodiment of range calculation 872. The range calculation 872 may be displayed on the screen. In the depicted embodiment, the range calculation 872 includes an evaluation level 275 that indicates that the rank calculation 866 is made for an agent 815 with a notification level 276 of a team 810. A plurality of ranges 874 are displayed along with calculating values 870 corresponding to the ranges 874. In the depicted embodiment, a calculating value 870a of five is applied to a performance metric when the performance metric is greater than 10. The calculating value 870 may be applied to the performance metric as a multiplier.

FIG. 19G is a drawing illustrating one embodiment of percentage calculation 876. The percentage calculation 876 may be displayed on the screen. In the depicted embodiment, the percentage calculation 876 includes an evaluation level 275 that indicates that the rank calculation 866 is made for an agent 815 with a notification level 276 of a team 810. A plurality of ranges 874 are displayed along with corresponding calculating values 870. In the depicted embodiment, a performance metric in the 0 to 10% range has a calculating value 870a of five while performance metric in the 10 to 75% range has a calculating value 870b of one.

FIG. 19H is a drawing illustrating one embodiment of tiered calculation 878. The tiered calculation 878 may be displayed on the screen. In the depicted embodiment, the tiered calculation 878 includes an evaluation level 275 that indicates that the rank calculation 866 is made for an agent 815 with a notification level 276 of a team 810. A plurality of ranks 868 and corresponding calculating values 870 are shown. In the depicted embodiment, a calculating value 870a of five is assigned for the first rank 868a.

FIG. 19I is a schematic block diagram illustrating one embodiment of performance data 1100. In the depicted embodiment, the performance data 1100 includes a performance score 1102, a payout value 1104, a payout amount 1106, a badge 1108 an incentive 1202, and award 1204, and the challenge 1206. The calculation of the performance score 1102 will be described hereafter. The payout value 1104 may be calculated from the payout amount 1106. The payout amount 1106 may be calculated from the performance score 1102 as will be described hereafter.

In one embodiment, the payout value 1104 is calculated as a function of a payout amount 1106. The payout value 1104 may be a monetary payment. Alternatively, the payout value 1104 may be the badge 1108. The performance score 1102 may be calculated from the performance rule 846, the payout 916, the payout range 918, the payout rank 920, the payout top percentage 922, and the tiered payout 924.

The badge 1108 may be awarded based on the payout value 1104. Alternatively, the badge 1108 may be awarded based on the performance score 1102. In one embodiment, the badge 1108 may be posted to social media when the badge is awarded. The incentive 1202 may be a reward, privilege, or the like. The award 1204 may be a recognition object. The challenge 1206 may be rare opportunity.

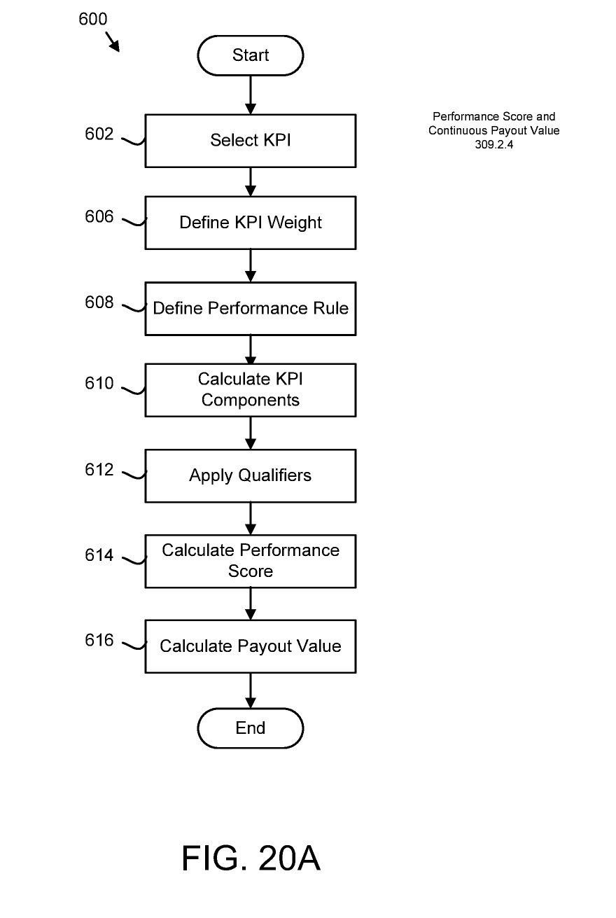

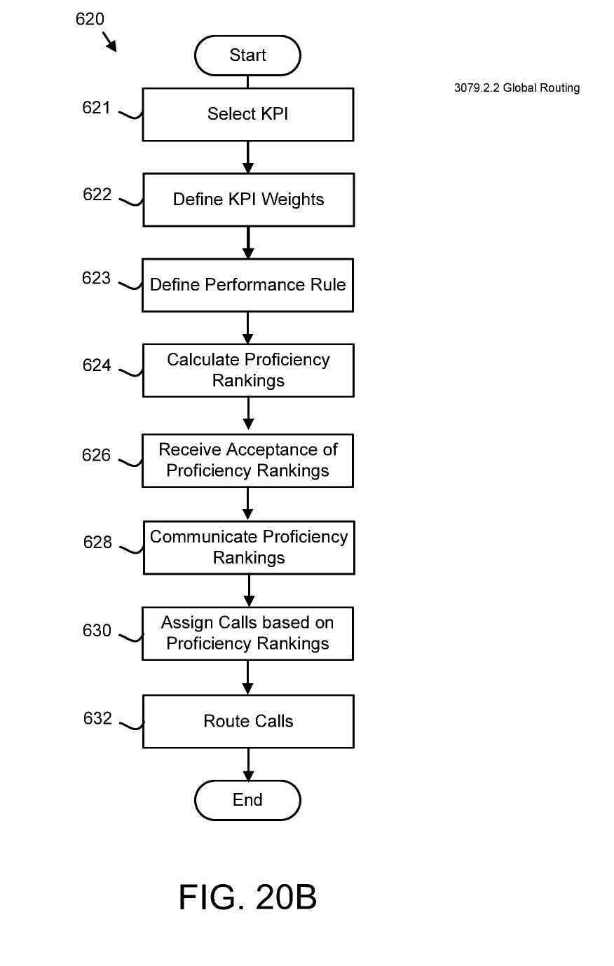

FIG. 20A is a schematic flowchart diagrams illustrating one embodiment of a performance score calculation method 600. The method 600 may calculate a performance score from the performance rule 846. The method 600 may be performed by the processor 305.

The method 600 starts, and one embodiment the processor 305 selects 602 one or more KPI 862. The KPI 862 may be selected 602 in response to an objective. In addition, the processor 305 defined 606 the KPI weights 864. The KPI weights 864 may be defined 606 in response to the objective.

In one embodiment, the processor 305 defined 608 the performance rule 846. The performance rule 846 may be defined 608 from the KPI 862, the KPI weights 864, and one or more of the payout 916, the payout range 918, the payout rank 920, the payout top percentage 922, and/or the tiered payout 924 for the performance rule 846.

The processor 305 may further calculate 610 the KPI complements 880 from the performance rule 846. In addition, the processor 305 may apply 612 the KPI qualifiers 882 to calculate 614 the performance score 1102. In addition, the processor 305 may calculate 616 a payout value 1104 from the performance score 1102.

In one embodiment, the performance score 1102 may trigger one or more actions in response to exceeding a threshold. For example, the performance score 1102 may trigger one of a badge 1108, an incentive 1202, and award 1204, and/or a challenge 1206. Alternatively, the performance score 1102 may trigger a coaching session. In a certain embodiment, the performance score 1102 triggers a quality monitoring session.

In a certain embodiment, an agent proficiency ranking 895 for routing calls may be determined as a function of the performance score 1102. Alternatively, the performance score 1102 may trigger a training event 892. For example, an agent 815 may be assigned to specific training event 892 in response to the performance score 1102 falling below the specified threshold.

If a performance score 1102 for one or more organizational units falls below the specified threshold, the embodiments may create training events 892 to address the low performance scores 1102. For example, the embodiments may create a sale closing training event 892 in response to the performance score 1102.

In one embodiment, the performance score 1102 may trigger the collecting of feedback. The feedback may be related to one or more training events 892. Alternatively, the feedback may be directed to one or more performance objectives.

The performance score 1102 may trigger the administration of a survey. The survey may be directed to an agent 815, a team 810, or the like. Alternatively, the survey may be directed to a customer.

In one embodiment, the performance score 1102 may trigger exception reporting. For example, if the performance score 1102 falls below an exception threshold, and exception report may be triggered.

The performance score 1102 may be analyzed to determine performance trends, data correlations, and the like. In addition, the performance score 1102 may identify performance behaviors in an agent 815, a team 810, and/or call center 805.

The performance score 1102 may trigger activities, actions, and the like related to all aspects of the call center system 100 as will be described hereafter. For example, the performance score 1102 may trigger actions in the call system database 405, the CRM database 410, the user database 415, the monitoring database 420, the unified database 425, the scheduling database 427, and/or the management learning system 426. In addition, the performance score may trigger actions in a quality assurance system, a survey system, and the like.

In one embodiment, the processor 305 continuously calculates 616 the payout value using the performance rule 846 for an organizational unit. In addition, the payout value 1104 may be calculated and awarded each of the plurality of specified achievement intervals. In one embodiment, a maximum possible payout value 1104 for the organizational unit is calculated 616 and displayed.

FIG. 20B is a schematic flow chart diagram illustrating one embodiment of a routing method 620. The method 620 may be performed by the processor 305. Alternatively, the method 620 may be performed by a computer program product. The computer program product may include a computer readable storage device such as the memory 310. The computer readable storage device may store program code that performs the method 620 when executed by the processor 305.

The method 620 starts, and in one embodiment the processor 305 selects 621 one or more KPI 862. The KPI 862 may be based on one or more of the phone system data 838, the CRM data 840, the WFM 842, the QM data 844, the LMS data 870, the internal data 875, the KPI components 880, the feedback data 885, and the evaluation data 890. The KPI 862 may be selected 621 based on our performance objective. Alternatively, an administrator may select 621 the KPI 862. The processor 305 further defines 622 KPI weights 864 for the KPI 862. In one embodiment, an administrator may define 622 the KPI weights 864.

In one embodiment, the processor 305 defines 623 the performance rule 846. The performance rule 846 may be defined 623 based on the KPI 862 and the KPI weights 864. The performance rule may be defined as a function of the call type. Alternatively, the performance rule 846 may be defined in response to an administrator selection.

The processor 305 may calculate 624 proficiency rankings using the performance rule 846. In one embodiment, the processor 305 continuously calculates 624 real-time global proficiency rankings as a function of the performance rule 846.

In one embodiment, the processor 305 receives 626 an acceptance of the proficiency rankings 895. The acceptance may be received 626 from an administrator. The processor 305 may further communicate 628 the proficiency rankings 895 to the call center system 100. The proficiency rankings 895 may be communicated 628 using an application programming interface (API).

The call center system 100 may automatically assign 630 an incoming call in response to the real-time global proficiency ranking 895. For example, the call center system 100 may assign 630 the incoming call based on the real-time global proficiency ranking 895

In one embodiment, the communication is automatically assigned 630 to a highest ranking available organizational unit. For example, the communication may be assigned 630 to a highest ranking agent 815 without regard to the global ranking 895 of the agent's team 810 and/or call center 805. Similarly, the communication may be assigned 630 to the highest ranking team 810 without regard to the global ranking 895 of the team's call center 805.

In a certain embodiment, the communication is automatically assigned 630 to a highest ranking available organizational unit at each level of an organizational hierarchy. For example, the communication may be automatically assigned 630 to a highest ranking call center 805. Within the highest-ranking call center 805, the communication may be automatically assigned 520 to the highest-ranking team 810. In addition, within the highest-ranking team 810, the communication may be automatically assigned 630 to the highest-ranking agent 805. The processor 305 may further route 632 calls as assigned.

By continuously calculating 624 the real-time global proficiency ranking 895 and assigning 630 communications in response to the real-time global proficiency ranking 895, the method 620 may assign 630 the communications to the organizational units with the best recent performance. As a result, the overall performance of the organization 800 is increased as the agents 815, teams 810, and call centers 805 that are currently performing best are assigned 520 the communications.

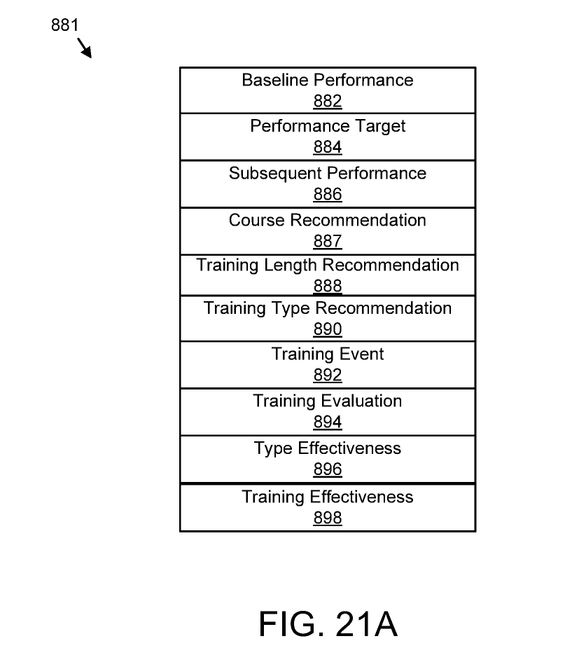

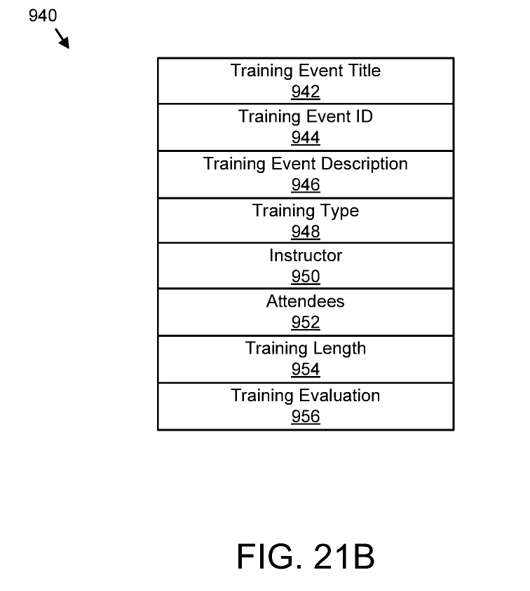

FIG. 21A is a schematic block diagram illustrating one embodiment of learning data 881. The learning data 881 may be stored in the learning management system database. The learning data 881 may be representative of data stored for one agent of a plurality of agents. The learning data 881 includes a baseline performance 882, a target performance 884, a subsequent performance 886, a course recommendation 887, a training length recommendation 888, a training type recommendation 890, a training event 892, a training evaluation 894, a type effectiveness 896, and a training effectiveness 898. The learning data 881 may be organized as a database, as linked data structures, as a flat file, or the like. The learning data 881 may be stored in a memory as will be described hereafter.

The baseline performance 882 measures the agent's performance before a training event 892. In one embodiment, the baseline performance 882 may include one or more performance metrics. The performance metrics may be calculated from the data of the call system database 405, the CRM database 410, and the user database 415. For example, a performance metrics may be a sales rate. The sales rate may be calculated from the number of calls, a number of customers contacted, and a number of sales.

The performance target 410 may specify desired performance by the agent. The performance target 410 may be a specified threshold of one or more performance metrics. In one embodiment, the performance target 410 is set by a supervisor for the agent and/or for a plurality of agents. Alternatively, the performance target 410 may be calculated based on the agent's baseline performance 882. The performance target 410 may include a plurality of targets for a plurality of performance metrics.

The subsequent performance 886 may measure the agent's performance after the training event 892. The subsequent performance 886 may include one or more performance metrics. The subsequent performance 886 may be calculated from the data of the call center database 405, the CRM database 410, and the user database 415 recorded during the interval from the training event 892 to a specified time such as the current time. For example, the subsequent performance 886 may measure an agent sales rate after the training event 892.

The course recommendation 887 may be identified for the agent based on the baseline performance 882 relative to the performance target 210. For example, the course recommendation 887 may be identified by determining the baseline performance 882 that is least satisfactory relative to the performance target 210. The course recommendation 887 may be identified as likely to mitigate the deficiency in performance.

The training length recommendation 888 may be identified from the magnitude of the deficiency between the baseline performance 882 and the performance target 210. For example, if the magnitude of the deficiency is large, the training length recommendation 888 may be for a longer period of time. However, if the magnitude of the deficiency is small, the training length recommendation 888 may be for a short period of time.

In one embodiment, the train length recommendation 225 is the length of the training event 892 that includes the course recommendation 887. For example, if the course recommendation is for a training event 892 with the length of one day, the training length recommendation 888 may be the length of the training event 892.

The training type recommendation 890 may be for a classroom type, a video type, an audio type, text type, a side-by-side coaching type. In one embodiment, the training type recommendation 890 is determined as a function of the type effectiveness 896 and the course recommendation 887.

The training event 892 may specify a n instance of the course recommendation 887. The training event 892 may include the course recommendation 887 the training length recommendation 888, the training type recommendation 890, and the training evaluation 894. In one embodiment, the training event 892 specifies one or more time intervals for the training event 892.

The training evaluation 894 may be a test, an agent evaluation, an instructor evaluation, or the like recorded at the end of the training event 892. For example, the training evaluation 894 may be a test of the agent's comprehension of the material presented in a training event 892.

The type effectiveness 896 may be calculated for the training type of the training event 892. The type effectiveness 896 may be calculated for an individual agent, a specified group of agents, or combinations thereof.

The training effectiveness 898 may be calculated from the baseline performance 882 and the subsequent performance 886 relative to the performance target 210 as will be described hereafter. The training effectiveness 898 may be calculated with the learning data 881. In addition, the training effectiveness 898 may be calculated with other call center data 100.

FIG. 21B is a schematic block diagram illustrating one embodiment of training event data 940. The training event data 940 may be stored in the learning management system database. The training event data 940 may be organized as a database, as lined data structures, as a flat file, or the like. The training event data 940 may be stored in a memory as will be described hereafter. The training event data 940 includes a training event title 942, a training event identifier 944, the training event description 946, a training type 948, an instructor 950, attendees 952, a training length 954, and a training evaluation 956. The training event data 940 may be stored for one or more training events 892.

The training event title 942 may briefly describe the training event 892. The training event identifier 944 may be a course number and may uniquely identify the training event 892. The training event description 946 may provide a more detailed description of the training event 892. The training type 948 may be of a classroom type, a video type, an audio type, a text type, and a side-by-side coaching type for the training event 892.

The instructor 950 may identify one or more instructors for the training event 892. The attendees 952 may identify each agent attending the training event 892. The training length 954 may be a length of the training event 892 measured in hours, days, or the like. The training evaluation 956 may include test scores from the training event 892, agent evaluations of the training event 892, instructor evaluations of the training event 892, and the like.

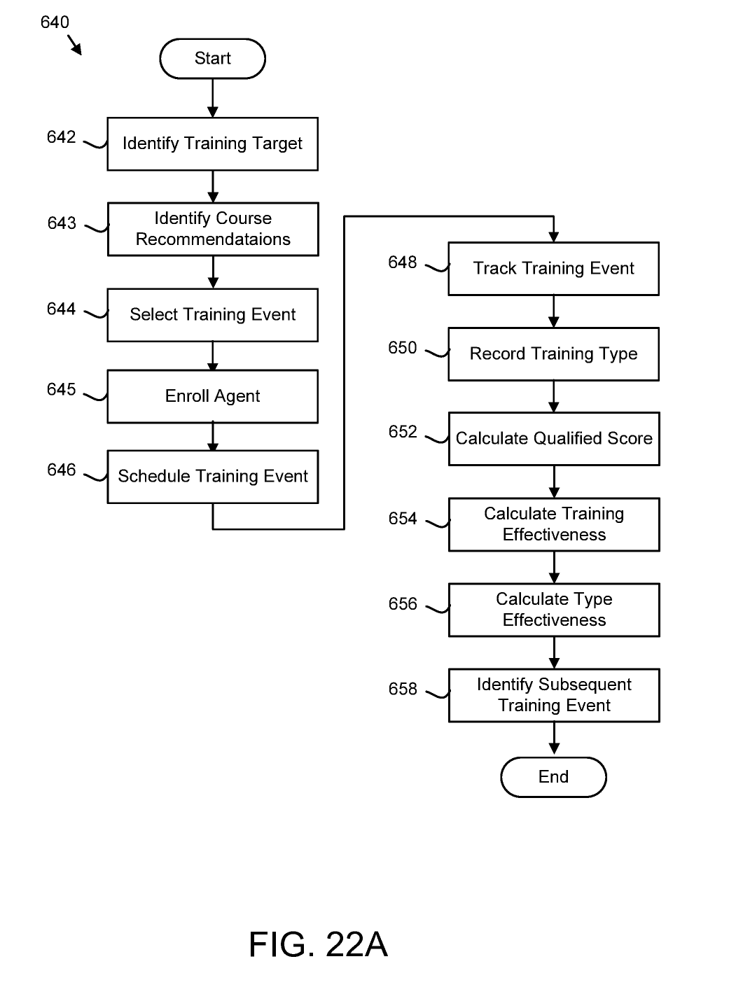

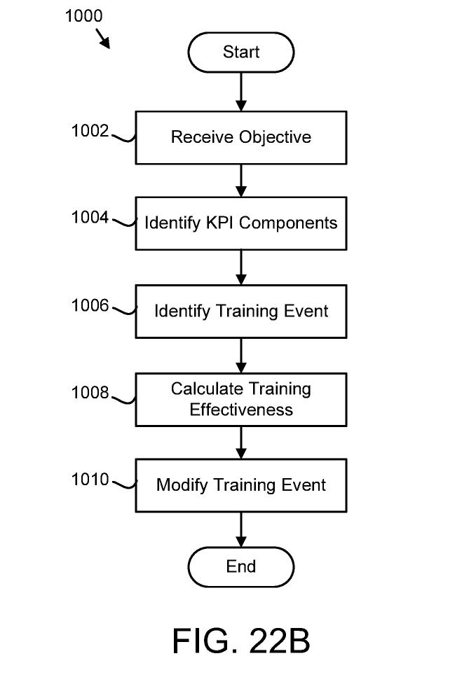

FIG. 22A is a schematic flowchart diagrams illustrating one embodiment of a learning management method 640. The method 640 may manage training and learning for the call center system 100. The method 640 may be performed using the processor 405. The method 640 may be embodied in a computer program product. The computer program product may comprise a computer readable storage medium storing program code. The program code may be executed by the processor 405 to perform the functions of the method 640.

The method 640 starts, and in one embodiment, the processor 305 identifies 642 a training event 892 for an agent based on the baseline performance 882 of the agent relative to the performance target 884. In one embodiment, the processor 305 identifies 643 one or more course recommendations 887. The processor 305 may further select 644 the training event 892 from the one or more course recommendations 887 based on the training length 954, the training evaluation 956, the training type 948, and the type effectiveness 896. Alternatively, the processor 305 may communicate the one or more course recommendations 220 to a supervisor and receive a selected course recommendation 887 from the supervisor.

The processor 305 may further enroll 645 the agent in the training event 892. In one embodiment, the processor 305 may automatically clear the training event 892 with a supervisor. For example, the processor 305 may communicate the training event 892 to the supervisor and receive an approval from the supervisor. In addition, the processor 305 may automatically enroll 645 the agent by entering the agent as an attendee and/or paying any training event fees.

The processor 305 may further schedule 646 the training event 892 within agent work hours. For example, the processor 305 may schedule 646 the training event 892 when the agent is not needed to work in the call center and the agent is available to work and is not off work or on vacation. In one embodiment, the processor 305 optimizes agent work requirements and agent schedules with the training event 892 for a plurality of agents.

The processor 305 may track 648 the training event 892. In one embodiment, the processor 305 tracks 648 the training event 892 in the learning management system 426. In one embodiment, the processor 305 tracks 648 the training event 892 by recording information regarding the training event 892 in the training event data 940 and the learning data 881.

In one embodiment, the processor 305 records 650 the training type 948 for each of the plurality of training events 892 attended by the agent. The training type 948 may later be retrieved to calculate the type effectiveness 896 as will be described hereafter.

In one embodiment, the processor 305 calculates 652 a qualified score for the train event 892.

The processor 305 may calculate 654 the training effectiveness 898. In one embodiment, the processor 305 calculates 654 the training effectiveness 898 from the baseline performance 882 and the subsequent performance 210. In a certain embodiment, the training effectiveness TE 896 is calculated using Equation 1, where k is a nonzero constant, SP is the subsequent performance 210, and BP is the baseline performance 882.

TE=k(SP−BP)/BP Equation 1

The processor 305 may further calculate the type effectiveness 896 and the method 640 ends. In one embodiment, the type effectiveness TE 896 is calculated using Equation 2 for each ith training effectiveness TE 896 of a training type 948 for n training effectiveness instances 250 of the training type 948.

TF=(ΣTEᵢ)/n Equation 2

The embodiments automatically identify a training event 892 for an agent. As a result, agents or more likely to receive needed training in a timely manner. In addition, the embodiments may manage the enrollment of the agent in the training event 892 and the scheduling of the training event 892, further accelerating the needed training.

The embodiments further calculate the training effectiveness 898. The training effectiveness 898 may be used to determine which training events 892 and course recommendations 220 are most appropriate for the agent in the future. The embodiments further calculate the type effectiveness 896 for the agent so that the most appropriate training type 948 may be selected for the agent in the future. As a result, agent training is more effective and agent performance is improved.

In one embodiment, the processor 305 identifies 658 a subsequent train event 892 based on the train effectiveness 898. The train event 892 may comprise at least one of a course recommendation 887, a training length recommendation 888, and a training type recommendation 890.

FIG. 22B is a schematic flowchart diagrams illustrating one alternate embodiment of a learning management method 1000. The method 1000 may identify training events 892 based on an objective. In addition, the method 1000 may modify training events 892 based on a training effectiveness 898. The method 1000 may be performed by a processor 305.

The method 1000 starts, and in one embodiment, the processor 305 receives 1002 an objective. The objective may be a KPI 862. Alternatively, the objective may be an administrator defined objective. The objective may be directed to one or more organizational units such as a call center 805, a team 810, and/or individual agents 815.

The processor 305 may identify 1004 one or more KPI components 880 based on the objective. In one embodiment, the processor 305 identifies 1004 KPI components 880 that support the objective. In one embodiment, competence in the identified KPI component 880 correlates directly to achieving the objective.

The processor 305 may identify 1006 a training event 892 as a function of the KPI components 880. In one embodiment, the identified train event 892 correlates with improved performance in the KPI complements 880.

The processor 305 may further calculate 1008 a training effectiveness 898 for the training event 892. In one embodiment, the training effectiveness 898 is calculated as a function of a baseline performance 882 and a subsequent performance 886 for the objective. The training effectiveness 898 may be calculated for one or more call centers 805, teams 810, and/or agents 815. The baseline performance 882 and the subsequent performance 886 may be calculated based on a performance score 1102. The function of the baseline performance 882 and the subsequent performance 886 may be one or more of a percent to the objective, a percent to the baseline performance 882, a standard deviation of the subsequent performance 886, a slope and R-squared linear regression model of the baseline performance 882 and subsequent performance 886, and a percent of agents 815 meeting the objective.

In one embodiment, the processor 305 modifies 1010 the training event 892 based on the training effectiveness 898 and the method 1000 ends. In one embodiment, the training event 892 is modified by adding elements that correlate with the KPI components 880 for the objective. In addition, the training event 892 may be modified by removing elements that do not correlate with the KPI components 880 for the objective.

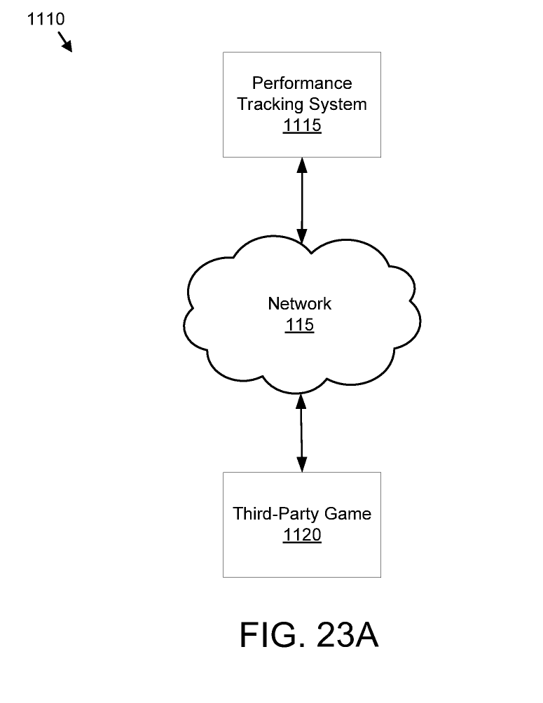

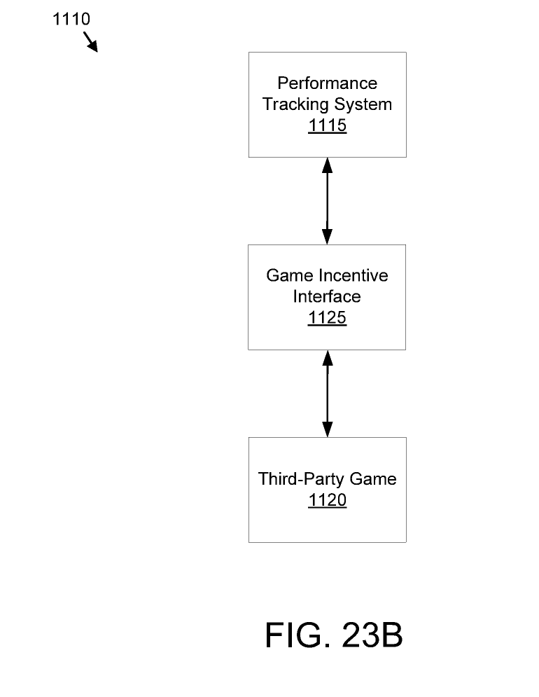

FIG. 23A is a schematic block diagram illustrating one embodiment of an incentive system 1110. The system 1110 includes a performance tracking system 1115, a network 115, and a third-party game 1120. The system 1110 translates performance scores from the performance tracking system 1115 into game points that may be used on the third-party game 1120. The performance tracking system 1115 may be embodied in the call center system 100.

Performance scores 1102 are important for motivating employees. Many employees and agents are enthusiastic about playing games such as electronic and/or video games. The embodiments described herein award game points for use in the third-party game 1120 in response to performance scores 1102 from the performance tracking system 1115. As a result, employees may be incentivized with rewards on their favorite game by the performance tracking system 1115 of their employer.

The performance tracking system 1115 may track the performance of one or more employees. In one embodiment, the performance tracking system 1115 is a call center performance tracking system 1115.

The network 115 may be the Internet, a wide-area network, a local area network, a mobile telephone network, a wireless network, or combinations thereof. The performance tracking system 1115 and the third-party game 1120 may communicate through the network 115.

The third-party game 1120 is independent of the performance tracking system 1115. Although in the depicted embodiment one performance tracking system 1115 communicates with one third-party game 1120, a plurality of performance tracking systems 105 may communicate with a plurality of third-party games 115. The third-party game 1120 may be accessed outside of the performance tracking system 1115. The play of the third-party game 1120 may be enhanced when a player spends game points within the third-party game 1120 to improve the playing experience. For example, a player may purchase virtual items, privileges, information, and the like that enhance the playing experience.

FIG. 23B is a schematic block diagram illustrating one alternate embodiment of the incentive system 1110. In the depicted embodiment, the performance tracking system 1115 and the third-party game 1120 communicate through a game incentive interface 1125. The game incentive interface 1125 may reside within the performance tracking system 1115, the third-party game 1120, or combinations thereof. In one embodiment, the game incentive interface 1125 is an open standard.

The game incentive interface 1125 may manage communications between the performance tracking system 1115 and the third-party game 1120, supporting the translation of performance scores from the performance tracking system 1115 into game points for the third-party game 1120. The game incentive interface 1125 may employ one or more packets as will be described hereafter.

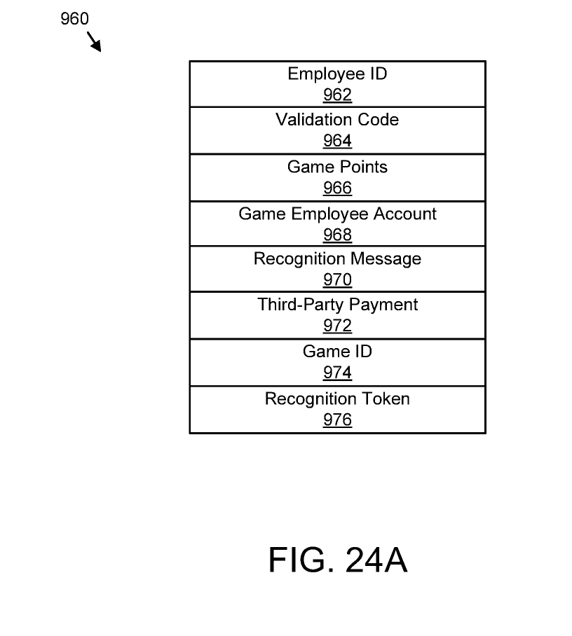

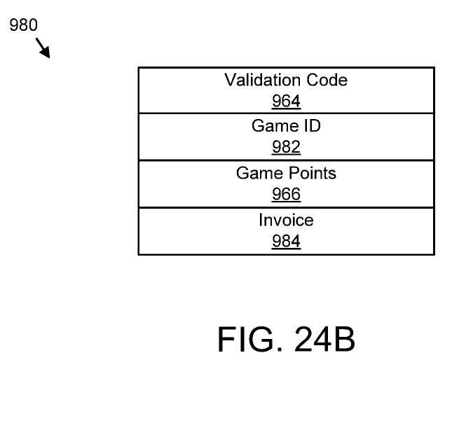

FIG. 24A is a schematic block diagram illustrating one embodiment of a point packet 960. The performance tracking system 1115 may communicate the point packet 960 through the game incentive interface 1125 in order to credit game points 966 to a game employee account for an employee in the third-party game 1120. The point packet 960 includes an employee identifier 962, a validation code 964, the game points 966, a game employee account 968, a recognition message 970, a third-party payment 972, a game identifier 974, and a recognition token 976.

The employee identifier 962 may identify the employee receiving the game points 966. Alternatively, the employee identifier 962 may identify a performance employee account for the employee. The employee identifier 962 may be internal to the performance tracking system 1115.

The validation code 964 may validate the crediting of the game points 966 to the game employee account corresponding to the game employee account 968 at the third-party game 1120. The validation code 964 may be one or more encryption keys.

The game points 966 are game points 966 for the third-party game 1120 that are awarded to the employee in response to a performance score 1102 of the performance tracking system 1115. For example, the employee may receive a performance score 1102 for transacting a specified number of sales. The game points 966 may be awarded to the employee in response to the performance score.

The game employee account 968 identifies an account of the employee within the third-party game 1120. The game points 966 may be credited to the game employee account corresponding to the game employee account 968.

The recognition message 970 may describe the performance score for which the employees receiving the game points 966 and include other encouraging messages. The recognition message 970 may be automatically generated by the performance tracking system 1115. In addition, the employee's supervisor may also generate the recognition message 970.

The third-party payment 972 may compensate the third-party game 1120 for the game points 966. Alternatively, the third-party payment 972 may account for the redemption of previously purchased game points 966. The game identifier 974 may identify a specific game and/or group of games at the third-party game 1120. The recognition token 976 may be displayed within the third-party game 1120 to recognize the employee's accomplishment and/or to signify the achievement of the performance score.

FIG. 24B is a schematic block diagram illustrating one embodiment of the game packet 980. The third-party game 1120 may communicate the game packet 980 to the performance tracking system 1115 to provide game points 966 to the performance tracking system 1115 that may be awarded to employees. The game packet 980 includes the validation code 964, the game identifiers 982, the game points 966, and an invoice 984.

The validation code 964 may be provided to the performance tracking system 1115 to validate future communications such as point packets 200 communicated through the game incentive interface 1125 to the third-party game 1120. The game identifier 974 may identify a specific game and/or group of games for which the game points 966 may be used.

The invoice 984 may bill the performance tracking system 1115 for the game points 966. Alternatively, the invoice may acknowledge payment for the game points 966.

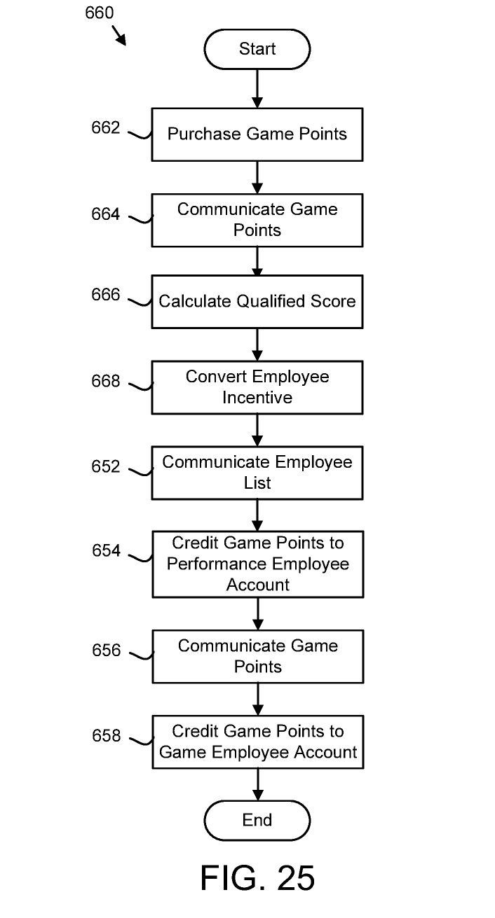

FIG. 25 is a schematic flow chart diagram illustrating one embodiment of a game incentive method 660. The method 660 may credit the game points 966 to a performance employee account in response to a performance score 1102. The method 660 may be performed by a computer.

The method 660 starts, and in one embodiment, the performance tracking system 1115 purchases 662 game points 966 from the third-party game 1120 through the game incentive interface 1125. In one embodiment, the performance tracking system 1115 communicates the purchase point packet 960 through the game incentive interface 1125 to the third-party game 1120. The point packet 960 may include a third-party payment 972. The third-party payment 972 may be a credit card number, a work order, or combinations thereof.

The third-party game 1120 may respond to the third-party payment 972 by communicating 664 a game packet 980 through the game incentive interface 1125 to the performance tracking system 1115. The game packet 980 may include the game points 966. In addition, the game packet 980 may include an invoice 984 acknowledging the purchase. The game packet 980 may also include the validation code 964.

The game points 966 may be denominated in a third-party game metric within the performance tracking system 1115. Alternatively, the game points 966 may be denominated in a performance tracking system metric within the performance tracking system 1115.

The performance tracking system 1115 may calculate 666 a qualified score such as a minimum performance score 1102 for receiving game points 966.

In one embodiment, the performance tracking system 1115 converts 668 an employee incentive into the game points 966. Alternatively, the game incentive interface 1125 may convert 668 the performance score 1102 into game points 966. In a certain embodiment, the game incentive interface 1125 converts 668 the game points 966 from the performance tracking system metric to the third-party game metric.

The performance tracking system 1115 may communicate 652 an employee list through the game incentive interface 1125 to the third-party game 1120. The third-party game 1120 may further link the employees of the employee list to game employee accounts within the third-party game 1120 in response to the employee list. In one embodiment, the third-party game 1120 creates the game employee accounts in response to the employee list.

The performance tracking system 1115 may credit 654 game points 966 to a game employee account 968 for an employee within the performance tracking system 1115 in response to the performance score. The performance tracking system 1115 may further communicate 656 the game points 966 in the point packet 960 through the game incentive interface 1125 to the third-party game 1120.

The third-party game 1120 may credit 658 the game points 966 to a game employee account 968 for the employee within the third-party game 1120 and the method 660 ends. In one embodiment, the third-party game 1120 validates the game points 966 using the validation code 964 of the point packet 960. The employee may then use the game points 966 while playing the third-party game 1120. As a result, the employees motivated within the third-party game 1120 for performance measured by the performance tracking system 1115.

The administrator and user may also view actual work. The actual work may include the start times and end times of the scheduling database 427. In one embodiment, the administrator enters the scheduled work 292. Alternatively, the scheduled work 292 may be entered by a scheduling algorithm.

The embodiments may be practiced in other specific forms. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. A method comprising:
defining, by use of a processor, a performance rule, the performance rule comprising one or more Key Performance Indicator (KPI) components and one or more KPI qualifiers, wherein each KPI component comprises one or more of a payout, a payout range, a payout rank, a payout top percentage, and a tiered payout, and each KPI qualifier comprises one or more of a range qualifier, a top percentage qualifier, and a rank qualifier; and
calculating a performance score from the performance rule.

2. The method of claim 1, the method further comprising continuously calculating a payout value using the performance rule for an organizational unit of a call center.

3. The method of claim 1, wherein the payout value is calculated as a function of a payout amount, and the performance score is calculated from the performance rule, the payout, the payout range, the payout top percentage, and the tiered payout.

4. The method of claim 1, wherein the one or more KPI components comprise one or more of CRM data, WFM data, QM data, performance objectives, metric definitions, learning management data, outcome data, feedback data, and evaluation data.

5. The method of claim 1, wherein the one or more KPI components comprise one or more of a product sale, a product upgrade, an average handle time, a time clock efficiency, a quality score, a schedule adherence, average seconds to answer, an average talk time.

6. The method of claim 1, wherein the payout value is a monetary payout.

7. The method of claim 1, wherein the payout value is a badge.

8. The method of claim 7, wherein the badge is posted to social media.

9. The method of claim 8, where the point-based payout value is calculated and awarded at each of a plurality of specified achievement intervals.

10. The method of claim 1, the method further comprising displaying a maximum possible payout value for the organizational unit.
